(19) United States
(12) Patent Application Publication
(10) Pub. No.: US 2025/0249380 A1
(43) Pub. Date: Aug. 7, 2025

(54) EXTRACTION OF OMEGA-3 FATTY ACIDS FROM LIPID-RICH MARINE ORGANISM USING A SUPERCRITICAL FLUID

(71) Applicant: AKSO Marine Biotech Inc., Hacketts Cove (CA)

(72) Inventors: Jianan Lin, Halifax (CA); Azadeh Kermanshahi-pour, Halifax (CA); Guangling Jiao, Hackett’s Cove (CA)

(21) Appl. No.: 18/433,632

(22) Filed: Feb. 6, 2024

(51) Int. Cl. B01D 11/04

(52) U.S. Cl. CPC B01D 11/0403; B01D 11/0492

(57) ABSTRACT

The present application provides a method for extracting fatty acids from a lipid-rich marine organism starting material comprising a) exposing the starting material to a supercritical fluid at a defined temperature and a defined pressure; and b) collecting the extract containing the fatty acids. The starting material may undergo various pretreatment steps prior to supercritical fluid extraction, including drying, pulverizing, and/or soaking in an organic solvent.

### FIELD

The present invention is related to a process for extracting omega-3 fatty acids from lipid-rich marine organism, such as sea cucumbers, using a supercritical fluid.

### BACKGROUND

Sea cucumbers, marine invertebrates under the phylum of Echinoderms and the class Holothuroidea, are ideal functional food with high nutritional values and have been exploited and used for hundreds of years as a food delicacy and medicines for a wide variety of diseases (Bahrami et al., 2014, Marine Drugs, 12(5), 2633-2667; Gomes et al., 2014, Rsc Advances, 4(56), 29365-29382). Several studies have shown that sea cucumbers are rich sources of essential amino acids, proteins, vitamins (vitamin A, B1, B2, and B3), mineral elements (zinc, iron, magnesium, calcium), and various bioactive molecules (e.g., fatty acids, saponins, sulphated polysaccharides, and collagens) with diverse therapeutic properties (Bordbar et al., 2011, Marine Drugs, 9(10), 1761-1805; Gomes et al, 2014). Therefore, sea cucumbers have attracted increasing interest in developing techniques to isolate valuable compounds and understanding their potential as pharmaceuticals, nutraceuticals, and functional food.

Cucumaria frondosa is known as the orange-footed sea cucumber or the northern sea cucumber. This is a dendrochirotic sea cucumber species with equally developed dendritic tentacles (Nelson et al., 2012, Reviews in Fisheries Science, 20(4), 212-219). It comprises three parts, including body walls, tentacles, and viscera (Hossain et al, 2020, Marine Drugs, 18(5), 274). The general practice of preparing sea cucumbers for the food market generally relies on cutting, removing, and trimming tentacles and internal organs during processing; as such, a considerable number of sea cucumber by-products containing valuable matters end up in landfills or disposed of in other ways. It has been reported that the viscera, representing 50% of the typical sea cucumber biomass, were discarded in recent years (Mamelona et al., 2010, Int. J. of Food Sci. & Tech., 45(10), 2119-2126). Currently, sea cucumbers are mainly sold as fresh and dried sea cucumbers. However, all the constituents are edible, and wastes (i.e., internal organs and tentacles) also contain various bioactive compounds. For example, it has been found that sea cucumbers with internal organs had higher antioxidant activity due to the internal organs containing abundant astaxanthin (Zhong et al., 2007, J. of Agri. and Food Chem., 55(4), 1188-1192). The growing market for nutraceutical supplements provides an opportunity to enhance profit margins by generating values from by-products that are typically discarded as wastes (Sanchez-Camargo et al., 2011, J. of Supercritical Fluids, 56(2), 164-173). Adverse environmental impact of wastes generated from marine organism processing has driven research into the extraction of value-added compounds, such as lipids and astaxanthin in shrimp residues (Sanchez-Camargo et al., 2011; Sanchez-Camargo et al., 2012, J. of Supercritical Fluids, 61, 71-77; Treyvaud Amiguet, et al., 2012, Food Chemistry, 130(4), 853-858), astaxanthin in blue crab shell wastes (Felix-Valenzuela et al., 2001, J. of Food Processing Engineering, 24(2), 101-112, and lipids in fish by-products (Haq et al., 2017, Waste and Biomass Valorization, 8(6), 1953-1967; Rubio-Rodriquez et al., 2012, J. of Food Engineering, 109(2), 238-248). However, there is limited research into the utilization of sea cucumber by-products. To increase the market value of sea cucumber and minimize the loss of valuable marine resources, it is important to develop an understanding of the extraction of value-added compounds from sea cucumber waste.

The market demand for foods that are high in polyunsaturated fatty acids (PUFAs), including omega-3 fatty acids including eicosapentaenoic acid (EPA) and docosahexaenoic acid (DHA), has led to an increase in sea cucumber consumption in recent years. EPA and DHA are long-chain omega-3 polyunsaturated fatty acids with more than 18 carbons. They promote anti-inflammatory activities and support cardiovascular health, brain function, and metabolism and immune function, and have some anti-cancer properties (Calder, 2015, Biochim. Biophys. Acta-Mol. Cell. Biol. Lipids, 1851(4), 469-484). It has been shown that the proximate composition of fresh Cucumaria frondosa with viscera (Newfoundland, Canada) contained 0.70% lipids; meanwhile, a high portion of PUFAs was detected in its extracts with a predominant EPA accounting for 43.2% of the total fatty acids content (Zhong et al., 2007). In addition, it has been found that 4.68% of the composition in fresh Cucumaria frondosa viscera (Newfoundland, Canada) was lipids, and the compositions of PUFAs and EPA were 33.01% and 27.76%, respectively, of the total fatty acids (Liu et al., 2021, Processes, 9(4), 703). Compared with fresh Apostichopus japonicus viscera that was reported to contain 0.66-2.12% lipids with EPA levels at 15.12-17.76% of the total fatty acids (Lee et al., 2012, Food Sci. and Biotech., 21(5), 1285-1291), Cucumaria frondosa would appear to be a preferred species to target omega-3-enriched products. Furthermore, researchers experimentally confirmed the total lipid content of frozen Cucumaria frondosa viscera (Nova Scotia, Canada) on the dry weight basis varied from 20.81 to 28.87%, with approximately 29-30% of PUFAs and 24-28% of EPA in the total fatty acids (Abuzaytoun, 2017, PhD Dissertation, Dalhousie University). In the same vein, air-dried and freeze-dried Cucumaria frondosa viscera (Newfoundland, Canada) were found to contain 25.69% and 23.19% of lipids on the dry weight basis with a similar composition of PUFAs and EPA at 30.58% and 28.71% as well as 31.65% and 27.97% of the total, respectively (Liu et al, 2021).

Current extractions on sea cucumber lipids mainly used conventional methods involving organic solvents like chloroform and n-hexane (Abuzaytoun, 2017; Budzinski et al., 2020, Profiling Analysis of Fatty Acids and Collagens Obtained from Sea Cucumbers. 141, 03006; Zhong et al., 2007). However, chlorinated solvents like chloroform that are toxic and potentially carcinogenic increase concerns on the environment and health of the workers; whereas other solvents like n-hexane and n-heptane demonstrate low extraction yield (Sanchez-Camargo et al., 2011). There is interest to eliminate/reduce the use of organic solvents, and seek greener alternatives to conventional extraction methods.

Supercritical fluid extraction, such as supercritical carbon dioxide (scCO₂) extraction methods, have been utilized in various fields. ScCO₂ is generally recognized as safe, i.e. non-toxic and non-flammable, inexpensive, and easy to remove due to its gas form at room temperature and pressure (Jiao & Kermanshahi, 2018, LWT, 98, 237-244; Sanchez-Camargo et al., 2011).

It is an object of the present invention to utilize supercritical fluid extraction for extraction of lipids from sea cucumber.

### SUMMARY

According to an aspect of the present invention, there is provided a method for extracting fatty acids from a sea cucumber starting material comprising: exposing the starting material to a supercritical fluid at a defined temperature and a defined pressure; and collecting the extract containing the fatty acids.

In one embodiment, the supercritical fluid is supercritical carbon dioxide. In another embodiment, the defined temperature is about 35° C. to about 75° C., and is preferably 75° C. In a further embodiment, the defined pressure is about 20 MPa to about 50 MPa, and preferably 45 MPa.

A co-solvent may be included with the supercritical fluid during the extraction. The co-solvent is preferably ethanol. In one embodiment, the ratio of the co-solvent to the starting material is about 1:1 to about 5:1 by weight, and preferably 2:1.

In yet another embodiment, the extraction is dynamic, i.e. the supercritical fluid flows continuously over the starting sample; the extraction is static extraction in which the supercritical fluid bathes the starting material; the extraction comprises a static extraction followed by a dynamic extraction; or the extraction comprises a dynamic extraction followed by a static extraction. During the dynamic extraction, the supercritical fluid flow rate may be about 10 ml/min, and the time of the dynamic extraction may be about 30 minutes. During the static extraction, the time may be 20 minutes.

In a further embodiment, the starting material is freeze dried, air dried including hot air dried, or fresh prior to the extraction. The starting material may undergo a pretreatment step in which it is soaked in ethanol, and/or the starting material is pulverized. Preferably, the starting material is pulverized and freeze dried; pulverized and hot air dried; pulverized, hot air dried and soaked in ethanol; or pulverized fresh material that is soaked in ethanol. These pretreatment steps may increase the yield of fatty acid extraction.

In one embodiment, the sea cucumber used in the method defined herein is Cucumaria frondosa. The fatty acids extracted from the sea cucumber can comprise polyunsaturated fatty acids (PUFAs), including omega-3 fatty acids, such as eicosapentaenoic acid (EPA) and docosahexaenoic acid (DHA).

### BRIEF DESCRIPTION OF THE DRAWINGS

The present invention will now be described in further detail having regard to the drawings in which:

FIG. 1 illustrates effects of temperature (35, 55, and 75° C.) on yields of fatty acids and selected omega-3 fatty acids at 50 MPa of pressure, 20 min of static extraction time, 60 min of dynamic extraction time, and 0:1 of co-solvent to biomass ratio. Error bars show the standard error of the mean for duplicate samples, n=2.

FIG. 2 illustrates effects of pressure (20, 35, and 50 MPa) on yields of fatty acids and selected omega-3 fatty acids at 55° C. of temperature, 20 min of static extraction time, 60 min of dynamic extraction time, and 0:1 of co-solvent to biomass mass ratio. Error bars show the standard error of the mean for duplicate samples, n=2.

FIG. 3 illustrates effects of static extraction time (20 and 30 min) on yields of fatty acids and selected omega-3 fatty acids at 55° C. of temperature, 20 MPa of pressure, 60 min of dynamic extraction time, and 0:1 of co-solvent to biomass mass ratio. Error bars show the standard error of the mean for duplicate samples, n=2.

FIGS. 4A-C illustrate effects of dynamic extraction time on yields of fatty acids and selected omega-3 fatty acids wherein, FIG. 4A illustrates dynamic extraction time increased from 30 min to 60 min at 55° C. of temperature, 35 MPa of pressure, 20 min of static extraction time, and 0:1 of co-solvent to biomass mass ratio. FIG. 4B illustrates dynamic extraction time increased from 60 min to 135 min at 30° C. of temperature, 10 MPa of pressure, 0 min of static extraction time, and 0:0 of co-solvent to biomass mass ratio. FIG. 4C illustrates dynamic extraction time increased from 60 min to 210 min at 75° C. of temperature, 50 MPa of pressure, 20 min of static extraction time, and 0:0 of co-solvent to biomass mass ratio. Error bars show the standard error of the mean for duplicate samples, n=2.

FIG. 5 illustrates effects of mass ratio of co-solvent to biomass (0:1, 1:1, 2:1) on yields of fatty acids and selected omega-3 fatty acids at 55° C. of temperature, 35 MPa of pressure, 20 min of static extraction time, and 60 min of dynamic extraction time. Error bars show the standard error of the mean for duplicate samples, n=2.

FIG. 6A illustrates actual vs. predicted values of yields of fatty acids.

FIG. 6B illustrates actual vs. predicted values of yields of the selected omega-3 fatty acids.

FIGS. 7A-F illustrate contour plots for fatty acid yields from scCO₂ extraction of Cucumaria frondosa viscera.

FIGS. 8A-F illustrate contour plots for the selected omega-3 fatty acid yields from scCO₂ extraction of Cucumaria frondosa viscera.

FIG. 9A illustrates the optimum of scCO₂ extraction with co-solvent for maximum fatty acids.

FIG. 9B illustrates the optimum of scCO₂ extraction with co-solvent for the maximum of the selected omega-3 fatty acids.

FIG. 9C illustrates the optimum of scCO₂ extraction with co-solvent for the maximum all responses.

FIG. 10A illustrates the optimum of scCO₂ extraction without co-solvent for the maximum fatty acids.

FIG. 10B illustrates the optimum of scCO₂ extraction without co-solvent for the maximum of the selected omega-3 fatty acids.

FIG. 10C illustrates the optimum of scCO₂ extraction without co-solvent for the maximum all responses.

FIG. 11A is a SEM image of hot air-dried Cucumaria frondosa viscera before scCO₂ extraction.

FIG. 11B is a SEM image of hot air-dried Cucumaria frondosa viscera after scCO₂ extraction.

FIG. 11C is a SEM image of freeze-dried viscera before scCO₂ extraction.

FIG. 11D is a SEM image of freeze-dried viscera after scCO₂ extraction.

### DETAILED DESCRIPTION

The features and benefits of the present disclosure are illustrated and described herein by reference to exemplary embodiments and is in no way intended to limit the invention, its application, or uses. This description of exemplary embodiments is intended to be read in connection with the accompanying drawings, which are to be considered part of the entire written description. Accordingly, the present disclosure expressly should not be limited to such embodiments, and features of each exemplary embodiment described herein may be combined with each other exemplary embodiment to form further embodiments.

As used herein, the term “about” means a range of values including the specified value, which a person of ordinary skill in the art would consider reasonably similar to the specified value. In embodiments, the term “about” means within a standard deviation using measurements generally acceptable in the art. In embodiments, “about” means a range extending to +/−10% of the specified value, or it could mean a range extending +/−1 units of the specified value.

In one aspect, the present specification relates to a process for extraction of fatty acids, including omega-3 fatty acids, from lipid-rich marine organisms. Examples include plankton, such as various calenoid copepod species and krill; and fish, such as sardines, anchovy, tuna, sea bass, and herring. Starting material for the extraction can also extend to waste from marine processing. Waste can include e.g. the organs and muscle of rays and sharks, the blubber from whales and seals, and fish roe.

An exemplary lipid-rich marine organism is sea cucumbers from the class Holothuridea. Any species of the class may be utilized with the present process; however, the Cucumaria frondosa variety is preferred. The extraction process may use any parts of the sea cucumber as a starting material, including tentacles, body walls, and viscera.

In one embodiment, the sea cucumber starting material may undergo one or more pre-treatment steps, which may increase the yield of fatty acid extraction. For example, the starting material can be dried, such as air-dried including hot air dried, or freeze-dried (lyophilization), to remove excess moisture. Other pretreatment steps that reduce moisture content of the starting material are also contemplated, such as oven drying, centrifugal drying, cyclone drying.

Preferably, freeze-fried or hot air-dried sea cucumber starting material is used in the process, as this pretreatment results in a starting material with low moisture content that can lead to an increased extraction yield. Fresh starting material that has been pretreated with an organic solvent as discussed below is also preferred. Without wishing to be bound by theory, the presence of moisture or water may create surface charges on the cells or alter solvent efficiency (molecule polarity difference and binding site competition) that interfere in the establishment of the contact between cells and the supercritical fluid or other extraction solvents. As will be evident in the examples presented below, freeze-dried starting material yielded the highest extraction yields, while the hot air-dried starting material and ethanol-soaked fresh material requires lower energy consumption and is readily scalable in industrial applications.

Alternatively, the starting material can be fresh, or be the product of a freeze-thaw cycle, i.e. not undergoing any drying step and containing the expected amount of moisture in the sample.

In another embodiment, a further pretreatment step includes pulverizing the starting material. This is believed to create homogeneity in the sample, increase surface area, and decrease particle size, which may positively affect extraction of fatty acids. This may take the form of shearing, grinding, crushing, comminution, etc., and may be carried out with e.g. grinders, roller mills, hammer mills, plate mills, ball mills, and cutters. Alternatively, or in addition to, the starting material can be sonicated to enhance cell disruption.

An additional pretreatment step that may be incorporated into the present process is exposure of the starting material to a suitable organic solvent. Examples of a suitable organic solvent include e.g. methanol, ethanol, butanol, propanol, isopropanol, hexane, and diethyl ether. In this pretreatment step, the starting material is exposed to the suitable organic solvent, such as by soaking or bathing the starting material in the organic solvent, prior to the supercritical fluid extraction. The length of time of the exposure of the starting material to the organic solvent is not particularly limiting, and may vary depending upon the weight of the starting material, but preferably the starting material is exposed to the organic solvent for at least 5 minutes, and preferably at least 20 minutes. In a preferred embodiment, the starting material is exposed to 95% ethanol or absolute ethanol prior to supercritical fluid extraction. This pretreatment step is particularly preferred when the starting material is fresh, i.e. a high moisture content sample, although starting material that has undergone a drying step and/or pulverizing may also be subject to exposure to a suitable organic solvent.

The starting material, with or without having undergone at least one or more of the pretreatment steps, is then subject to extraction with a supercritical fluid. The starting material is first placed in an extractor device together with the supercritical fluid at specific pressure and temperature conditions. The supercritical fluid is typically passed through a heater and/or a high-pressure pump until it reaches the desired temperature and pressure. The starting material is then exposed to the supercritical fluid for a predetermined amount of time, during which various compounds are extracted from the starting material. This exposure can take the form of a static extraction, in which a fixed volume of the supercritical fluid is in admixture with the starting material, or a dynamic extraction, in which a continuous flow of the supercritical fluid flows continuously over the starting material. In an alternative embodiment, the process employs a static extraction followed by a dynamic extraction.

After extraction, the fatty-acid rich extract is collected. This extract may enter one or more separators that allows for fractionation of the components of the extract. Alternatively, the extract may undergo additional treatment, such as transesterification, to allow identification and/or quantification of lipids in the extract by certain methods, such as gas chromatography (e.g. GC-FID).

Extraction apparatuses are available commercially, such as the SFT-110 SFE System from Supercritical Fluid Technologies Inc. Larger scale systems can also be utilized.

Carbon dioxide is a preferred supercritical fluid for the extraction of active components from the starting material. Its critical temperature is 31.06° C., its critical pressure is 73.83 bar, and its critical density is 0.460 g/cm³. At a point above these critical conditions, carbon dioxide is regarded as supercritical carbon dioxide, which is able to extract heat labile compounds, such as fatty acids, including PUFAs. The relatively low critical temperature of carbon dioxide also minimizes the degradation of fatty acids that can occur at higher temperatures. Carbon dioxide is also non-toxic, non-flammable, non-polluting, recoverable, inexpensive, and inert.

However, alternative supercritical fluids, which may be based on the intended end use of the extract. Examples of alternative supercritical fluids include but are not limited to hydrogen, nitrogen, methane and ethane, may also be employed.

A first step in the supercritical fluid extraction of fatty acids from the starting material is exposing the starting material to the supercritical fluid in an extractor device. In an embodiment in which the starting material is sea cucumber, such as sea cucumber viscera, the supercritical fluid is preferably carbon dioxide, and the scCO₂ is preferably at a pressure of about 20 to about 50 MPa, and more preferably about 45 MPa when it is exposed to the starting material. The scCO₂ is preferably at a temperature of about 35° C. to about 75° C., and more preferably about 75° C. These parameters may be optimized when different starting material and different weights of starting material are utilized.

In one embodiment, the extraction with the supercritical fluid is a static extraction, with the extraction time ranging from about 1 minute to about 60 minutes. This time may vary depending upon the weight of the starting sample in the extraction. For example, a starting sample weighing about 1.5 g has a preferred time of 20 minutes. In another embodiment, the extraction with the supercritical fluid is a dynamic extraction, with the dynamic extraction time ranging from about 1 minute to about 210 minutes. This time may vary depending upon the weight of the starting material. For example, a starting sample weighing about 1.5 g has a preferred time of 30 minutes. The flow rate of the supercritical fluid may vary, but is preferably about 10 ml/min. In one embodiment, the sample material undergoes a static extraction followed by dynamic extraction. Preferably, the extraction comprises a static extraction followed by a dynamic extraction, with extraction times of about 20 and 30 minutes, respectively.

In some embodiments, a co-solvent can be used in addition to the supercritical fluid. The co-solvent would be mixed with the starting material prior to commencing the supercritical fluid extraction. Normally, co-solvents are liquids at ambient conditions. Preferred examples of co-solvents are ethanol, methanol, and water; most preferred is 95% ethanol. In one embodiment, if the starting material was exposed to an organic solvent as a pre-treatment step, the organic solvent can be recovered and used as the co-solvent during the supercritical fluid extraction.

The ratio of co-solvent to starting material may vary, with a preferred range of about 1:1 to 5:1, based on the starting weight of the co-solvent and the starting material. More preferably the range of co-solvent to starting material is about 2:1.

### Examples

### Materials

Frozen fresh and hot air-dried Cucumaria frondosa viscera were provided by AKSO Marine Biotech Inc. Cucumaria frondosa was harvested in the Finishing Area FAO 21 from July to November 2019 and kept frozen until processed in the plant. After processing, the separated viscera were stored in a cooler and delivered to the Biorefining and Remediation Laboratory.

Ultra-high purity liquid carbon dioxide, nitrogen, helium, air, and hydrogen were purchased from Praxair (Dartmouth, Nova Scotia, Canada). The liquid carbon dioxide was used as the solvent in scCO₂ extraction. Internal standard methyl nonadecanoate (C19:0 methyl ester) and external standards 37 FAME mix standard and PUFA NO. 3, butylated hydroxytoluene (BHT), sodium chloride (NaCl), potassium chloride (KCl), sodium sulphate (Na₂SO₄), anhydrous methanol, agent grade acetyl chloride, Whatman #1 filter paper, and glass wool were supplied by Sigma Aldrich Ltd (Oakville, Ontario, Canada). ACS grade toluene, sodium bicarbonate (NaHCO₃), GC grade hexane, and GC grade chloroform were purchased from VWR International Ltd (Mississauga, Ontario, Canada). 95% ethanol was purchased from Tupper Med Store at Dalhousie University (Halifax, Nova Scotia, Canada). All chemicals were used as received.

### Methods

### Sample Preparation

To evaluate the effects of different pre-treatments on scCO₂ extraction, frozen fresh sea cucumber viscera were freeze-dried using a bench-top freeze dryer (Labconco Freezone 2.5 L Bench-top Freeze Dry System, Kansas City, MO, USA). The freeze-drying method was adopted from (Liu et al., 2021). Fresh Cucumaria frondosa viscera were separated into several portions and put in 20 mL tubes for freezing overnight at −20° C., and then transferred to freeze dryer flasks. The flasks were loaded onto the freeze dryer and set the temperature and pressure at around −87° C. and 0.014 mBar for two days. Hot air-dried samples were prepared by AKSO Marine Biotech Inc. The harvested Cucumaria frondosa was thawed and washed with seawater, then eviscerated. The collected viscera were dried under hot air at 40-45° C. for 48 h.

Fresh and dehydrated samples were ground in an electric grinder (Shardor Technology Ltd., China) and sieved using an 18 mesh-sized sieve (<1 mm). The ground samples were hermetically sealed in airtight zippered freezer bags and stored at −20° C. until required.

### Moisture Content Determination

Moisture content was measured to determine the lipid content on a dry weight basis, which makes all the response factors in the same unit for comparison. The moisture content of sea cucumber viscera samples was determined gravimetrically using a vacuum oven (Across International, Livingston, NJ, USA) according to a method modified from AOAC International (2006) Official Methods of Analysis. Approximately 1.5 g of samples in aluminum dishes were weighed on an analytical balance (Mettler Toledo AT261 Analytical Balance, Columbus, OH, USA) and dried at 105° C. until the weight did not change. The measurement was carried out in triplicate for each sample.

### Extraction

### The Bligh and Dyer Method

Crude oils of Cucumaria frondosa viscera were extracted according to a modified Bligh & Dyer method (Bligh & Dyer, 1959, Canadian Journal of Biochem. and Phys., 37(8), 911-917; Christie, 1982, Lipid analysis: Isolation, separation, identification, and structural analysis of lipids (2nd ed.)). Approximately 1.5 g of hot air-dried samples in quadruplicate were weighed, followed by adding 6 mL of distilled water to make up to 80% of the moisture content. 7 mL of chloroform with 0.01% BHT and 15 mL of methanol (chloroform:methanol:water (v/v/v)=1:2:0.8) were also added. The mixture was vortexed vigorously until the mixture forms a single phase. The well-homogenized mixture was filtered, and then the tissue residue, the tube, and the filter paper were rinsed with 7.5 mL of chloroform. The filtrate was mixed with 7.5 mL of 0.88% KCl solution to induce layer separation. The resulting proportions of chloroform:methanol:water (v/v/v) was 2:2:1.8 in the final mixture. Allowed to centrifuge and separate, the chloroform layer was collected. Na₂SO₄ was added to absorb extra moisture. Following the filtering, the filter paper with Na₂SO₄ was rinsed using 3-4 mL of chloroform. The lipids-rich chloroform was recovered and evaporated using a rotary evaporator (Buchi, Switzerland) under 45° C., 258 bar. The extracts were further dried under the nitrogen, weighed, and stored at −20° C. The extract was considered as the global extract, determined using Eq. (1):

$$Global extraction yield = \frac{Mass of the extract}{Mass of dehydrated sea cucumber viscera} \qquad ( 1 )$$

For selected starting materials, an improved ultrasonic-assisted Bligh & Dyer method was employed. After adding water, chloroform, and methanol to the ratio of 1:2:0.8 (v/v/v), the mixture was covered with a stream of nitrogen and placed in an ultrasonic water bath (Branson 2510 sonicator, Brookfield, Connecticut, United States) for 10 min. The subsequent steps are consistent with the previous description.

### ScCO₂ Extraction

The scCO₂ extraction apparatus (SFE-110, Supercritical Fluid Technologies Inc., USA) comprised a CO₂ cylinder, a CO₂ pump, a co-solvent pump, a heating chamber, a sample vessel, collection vials, and a flow meter. Approximately 1.5 g of air-dried and freeze-dried Cucumaria frondosa viscera and certain quantities of fresh samples with 1.5 g of dry weight along with co-solvent (95% ethanol) were loaded in a 10 mL sample vessel directly. In the case of fresh starting material, such as sea cucumber viscers, co-solvent was introduced into the vessel through the co-solvent pump. The tightly sealed vessel was connected to the system. The extraction procedure included static and dynamic phases. Once the temperature and pressure achieved the setting in the closed system, the static stage was recorded. This step allows contact between the sample and the supercritical solvent. After the pre-determined time of static soaking, the static/dynamic valve was opened, and the restrictor valve was slightly adjusted to ensure scCO₂ was continuously drained through the vessel at approximately 10 mL/min for dynamic extraction. The extraction time was recorded as well. Two pre-weighed vials (a collection vial and a trap vial) were used to collect the extracts. After extraction, the system was vented until the pressure of the vessel dropped to atmospheric pressure and the temperature reached the room temperature. The vessel was opened to remove the residues and then reconnected to the system for washing. 95% ethanol was purged using the co-solvent pump to rinse the line and the vessel to collect the remaining extract. The washing solution was evaporated in a rotary evaporator until no solvent was trapped. The washout extract after evaporation and the original extract were regarded as the global extract, weighed, covered with an inert atmosphere of nitrogen, and stored at −20° C. The global extraction yield was calculated as shown in Eq. (1).

To verify whether ethanol-soaking pre-treatment can improve the extraction yields of hot air-dried and fresh samples, approximately 1.5 g of hot air-dried Cucumaria frondosa viscera and certain quantities of fresh samples with 1.5 g of dry weight were soaked into 3 g of 95% ethanol for two hours, respectively. The remaining co-solvent for fresh sample trials (˜12 g) was pumped into the system through the co-solvent pump and then extracted following the method mentioned above.

### Transesterification

Transesterification after Extraction

Fatty acids were converted into fatty acid methyl esters (FAMEs) using methanolic HCl transesterification. Briefly, a certain amount of toluene with 0.01% BHT was added to the extract, followed by transferring 1.5 mL of extract-rich toluene into a clean tube with dried methyl C19:0 (10 mg/mL). 3 mL of 5% methanolic HCl was added to the mixture, and transesterification was performed at 100° C. for one hour. During the process, fatty acids were methylated to FAMEs. After reaction completion, tubes were removed from the heating block and cooled to the room temperature. 2 mL of 5% NaCl solution was added. After centrifugation, the organic phase was collected in a new tube, while the aqueous phase was re-extracted using hexane three times. With the assistance of centrifugation, the separated hexane layer was collected. 2 mL of 2% NaHCO₃ solution was added to the pooled organic layers to remove excess acid, and then the mixture was centrifuged. The upper layer was transferred to another new tube, whereas the aqueous layer was washed three times with hexane, then centrifuged, and transferred. A spoonful of Na₂SO₄ was added to adsorb the water. Following the filtration, the water-free mixture was obtained. The filtrate was collected in a pre-weighed tube and dried under a stream of nitrogen. The dried, derivatized product was weighed, covered with nitrogen, and stored at −20° C. for further processing.

### In-Situ Transesterification

In in-situ transesterification, methanolic HCl was applied to four replicates of identical Cucumaria frondosa viscera (dried and fresh) with 10 mg/ml of methyl C19:0 added as the internal standard. An improved method with the assistance of an ultrasonic water bath was adopted. Prior to adding the methanolic HCl, the sample along with toluene containing 0.01% BHT was treated in an ultrasonic water bath for several minutes. The transesterification reaction was the same as described in the previous.

### Fatty Acids Profiles in GC

The methyl esters obtained from transesterification were diluted using hexane and transferred to a pre-labelled amber GC vial covered with nitrogen. The external standards—37 FAME mix and PUFA NO. 3—were used as references for qualitative analysis. Gas chromatography equipped with flame ionization detector (GC-FID, Agilent 7890B GC, California, United States) and DB-23 column was applied to analyze samples and standards. The carrier gas was helium, using a split ratio of 1:50. The detector and injector temperatures were 280 and 250° C., respectively. The column was maintained at 50° C. for 1 min, raised from 50 to 215° C. at 25° C./min, increased to 230° C. at 4° C./min, and finally maintained at 230° C. for 5 min. One microliter of the methyl esters was injected onto the column and the fatty acids were identified by a comparison of the retention times with those of the methyl ester standards.

Fatty acid amount in the sample was quantified by comparison of peaks from GC analysis between a known amount of added methyl C19:0 (Eq. (2) & (3)):

$$Amount of a fatty acid = \frac{peak {area}_{a fatty acid} \times {amount}_{m ethyl C 19 : 0}}{peak {area}_{m ethyl C 19 : 0}} \qquad ( 2 )$$

$$Amount of total fatty acid = \frac{\sum ( peak {area}_{a fatty acid} \times {amount}_{m ethyl C 19 : 0} )}{peak {area}_{m ethyl C 19 : 0}} \qquad ( 3 )$$

The fatty acid yields on the dry weight basis (g/100 g of biomass used; dry weight basis means the moisture portion should be subtracted from the original sample weight) were calculated as Eq. (4):

$$Fatty acid yields = \frac{A mount of total or certain fatty acids}{A mount of biomass used on the dried weight basis} \qquad ( 4 )$$

Results of fatty acid composition were expressed as the percentage of a fatty acid in the total fatty acids. Furthermore, comparing the total fatty acids with the fatty acids recovered by in-situ transesterification, the recovery efficiency (% recovery) was calculated as Eq. (5):

$$Fatty acids recovery efficiency = \frac{Fatty acid yields of {sc CO}_{2} extraction}{Fatty acid yields of conventional extraction} \times 100 \% \qquad ( 5 )$$

### Morphological Imaging

Hitachi S-4700 FE Scanning Electron Microscope (Chiyoda, Tokyo, Japan) was used to investigate morphological structure changes due to different pre-treatments. To avoid charge-up effects on the surface and promote the emission of secondary electrons, dried samples were mounted on aluminum stubs, coated with gold-palladium alloy for 260 s, obtaining 20-nanometers coated layers. The coated samples were scanned using the scanning electron microscope at an accelerating voltage of 1.5 kV.

### Experimental Design and Statistical Analysis

To optimize yields of omega-3 fatty acids from the scCO₂ extraction of Cucumaria frondosa viscera, a preliminary screening was carried out using single-factor experiments by fixing all parameters except one variable. In the preliminary screening, the temperature of 35, 55, and 80° C., the pressure of 20, 35, and 50 MPa, the dynamic extraction time at 30, 60, 135, and 210 min, the static time at 0, 10, 20, and 30 min, and the co-solvent (95% ethanol) to biomass mass ratio at 0 (no co-solvent added), 1, and 2 were tested on hot air-dried samples. The preliminary screening experiments were performed in duplicate. According to the results from the preliminary screening, the range of selected process variables was specified.

A response surface method, central composite inscribed (CCI) design, with four parameters—temperature (35-75° C.), pressure (20-50 MPa), dynamic extraction time (30-70 min), and mass ratio of co-solvent to biomass (0-2)—was created in Minitab 19 (Minitab Inc., State College, PA, USA). Each factor was examined at five levels: −α, −1, 0, +1, and +α (Table 1).

TABLE 1
Process variables and their coded levels.

| | Levels | | | | |
|---|---|---|---|---|---|
| Process variables | −α | −1 | 0 | +1 | +α |
| Temperature (° C.) | 35 | 45 | 55 | 65 | 75 |
| Pressure (MPa) | 20 | 27.5 | 35 | 42.5 | 50 |
| Dynamic extraction time (min) | 30 | 40 | 50 | 60 | 70 |
| Ratio of co-solvent to biomass (w/w) | 0 | 0.5 | 1 | 1.5 | 2 |

The design included center points that run seven times, also 16 cube points and 8 axial points, resulting in 31 trials (Table 2). The total fatty acid yields and selected omega-3 fatty acid yields (i.e., DHA and EPA) were evaluated as the response variables for optimization.

TABLE 2
The CCI design of process variables with corresponding experimental responses (yields
of the total fatty acids and the selected omega-3 fatty acids in g/100 g of samples
on the dry weight basis), predicted values (predicted yields of the total fatty
acids and the selected omega-3 fatty acids in g/100 g of samples on the dry weight
basis), and recovery efficiencies (compared with the maximum fatty acid contents
obtained from in-situ transesterification of freeze-dried samples).

| | X₁ | X₂ | X₃ | X₄ | Fatty acids yields | | | Selected omega-3 yields | | |
|---|---|---|---|---|---|---|---|---|---|---|
| # | (° C.) | (MPa) | (min) | (w/w) | Exp. | Predict | Recovery % | Exp. | Predict | Recovery % |
| 1 | 45 | 27.5 | 40 | 0.5 | 12.992 | 12.698 | 58.611 | 2.662 | 2.578 | 64.369 |
| 2 | 65 | 27.5 | 40 | 0.5 | 14.347 | 14.260 | 64.725 | 2.812 | 2.815 | 67.978 |
| 3 | 45 | 42.5 | 40 | 0.5 | 13.374 | 13.306 | 60.336 | 2.554 | 2.741 | 61.748 |
| 4 | 65 | 42.5 | 40 | 0.5 | 15.785 | 15.815 | 71.212 | 3.032 | 3.040 | 73.308 |
| 5 | 45 | 27.5 | 60 | 0.5 | 12.591 | 13.210 | 56.805 | 2.616 | 2.685 | 63.261 |
| 6 | 65 | 27.5 | 60 | 0.5 | 14.909 | 14.778 | 67.260 | 2.835 | 2.868 | 68.534 |
| 7 | 45 | 42.5 | 60 | 0.5 | 13.210 | 13.460 | 59.597 | 2.619 | 2.690 | 63.331 |
| 8 | 65 | 42.5 | 60 | 0.5 | 15.937 | 15.976 | 71.900 | 2.813 | 2.936 | 68.013 |
| 9 | 45 | 27.5 | 40 | 1.5 | 14.824 | 15.151 | 66.879 | 2.989 | 2.971 | 72.264 |
| 10 | 65 | 27.5 | 40 | 1.5 | 15.569 | 15.270 | 70.237 | 3.088 | 3.040 | 74.672 |
| 11 | 45 | 42.5 | 40 | 1.5 | 15.842 | 15.922 | 71.471 | 3.131 | 3.112 | 75.700 |
| 12 | 65 | 42.5 | 40 | 1.5 | 17.240 | 16.988 | 77.776 | 3.197 | 3.243 | 77.286 |
| 13 | 45 | 27.5 | 60 | 1.5 | 14.979 | 14.895 | 67.577 | 2.998 | 3.010 | 72.498 |
| 14 | 65 | 27.5 | 60 | 1.5 | 14.591 | 15.021 | 65.825 | 3.114 | 3.026 | 75.289 |
| 15 | 45 | 42.5 | 60 | 1.5 | 14.849 | 15.308 | 66.988 | 2.890 | 2.993 | 69.880 |
| 16 | 65 | 42.5 | 60 | 1.5 | 16.143 | 16.382 | 72.827 | 2.974 | 3.072 | 71.915 |
| 17 | 35 | 35 | 50 | 1 | 14.676 | 14.189 | 66.207 | 2.996 | 2.904 | 72.440 |
| 18 | 75 | 35 | 50 | 1 | 16.650 | 16.824 | 75.117 | 3.247 | 3.219 | 78.508 |
| 19 | 55 | 20 | 50 | 1 | 12.909 | 12.827 | 58.238 | 2.540 | 2.662 | 61.412 |
| 20 | 55 | 50 | 50 | 1 | 15.030 | 14.795 | 67.805 | 3.119 | 2.870 | 75.405 |
| 21 | 55 | 35 | 30 | 1 | 14.608 | 15.044 | 65.901 | 2.953 | 2.974 | 71.409 |
| 22 | 55 | 35 | 70 | 1 | 15.704 | 14.949 | 70.848 | 3.056 | 2.909 | 73.884 |
| 23 | 55 | 35 | 50 | 0 | 13.894 | 13.867 | 62.683 | 2.817 | 2.672 | 68.111 |
| 24 | 55 | 35 | 50 | 2 | 17.019 | 16.725 | 76.782 | 3.176 | 3.200 | 76.789 |
| 25 | 55 | 35 | 50 | 1 | 15.690 | 15.394 | 70.784 | 3.064 | 2.989 | 74.069 |
| 26 | 55 | 35 | 50 | 1 | 15.456 | 15.394 | 69.731 | 3.030 | 2.989 | 73.265 |
| 27 | 55 | 35 | 50 | 1 | 15.813 | 15.394 | 71.341 | 2.928 | 2.989 | 70.803 |
| 28 | 55 | 35 | 50 | 1 | 15.830 | 15.394 | 71.414 | 3.109 | 2.989 | 75.165 |
| 29 | 55 | 35 | 50 | 1 | 15.020 | 15.394 | 67.763 | 2.812 | 2.989 | 67.991 |
| 30 | 55 | 35 | 50 | 1 | 14.537 | 15.394 | 65.583 | 2.896 | 2.989 | 70.011 |
| 31 | 55 | 35 | 50 | 1 | 15.413 | 15.394 | 69.536 | 3.082 | 2.989 | 74.520 |

Overall, the response surface methodology combines regression modelling and analysis of variance (ANOVA), resulting in a model (Eq. (6)):

$$Y = {β}_{0} + {\sum }_{i = 1}^{k} {β}_{i} {X}_{i} + {\sum }_{i = 1}^{k} {β}_{i i} {X}_{i}^{2} + {\sum }_{i = 1} {\sum }_{i < j} {β}_{i j} {X}_{i} {X}_{j} \qquad ( 6 )$$

where Y represents the response, Xᵢ and Xⱼ are the independent variables, β₀ is the intercept coefficient, and βᵢ, βᵢᵢ, and βᵢⱼ are the linear, quadratic, and interaction coefficients.

The independence assumption was met due to the randomization of the run orders. The significance of each model term at a significance level of 5% was examined. The determination coefficient (R²) and p-values of lack-of-fit were used to evaluate the goodness of the fits to the regression models. Additional runs at the optimum conditions were conducted to validate the model, and the experimental results were compared with the model prediction. Three-dimensional surface plots and contour plots were generated by varying two variables within the studied range and holding the other two consistent.

### Results

### Preliminary Screening

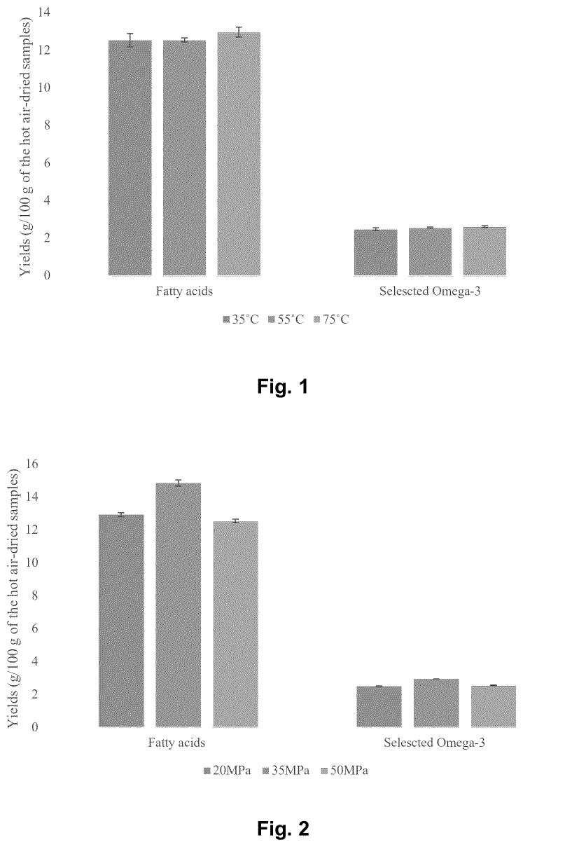

Single-factor experiments were employed to identify important factors that should be considered in a response surface design for scCO₂ extraction of fatty acids from Cucumaria frondosa viscera. The yields of the total fatty acids and selected Omega-3 fatty acids versus potential factors were shown in FIGS. 1-5.

FIG. 1 shows that as temperature increased, yields of fatty acids changed marginally with no curvature. The one-way ANOVA suggested temperature had no significant effect on responses (p-values >0.05).

In FIG. 2, the change of yields as the function of pressure indicated fatty acid yields increased and then decreased with pressure increased. The one-way ANOVA proposes pressure had significant effects on all the responses (p-values <0.05). Also, the Tukey pairwise comparisons supported a curvature for fatty acid yields at the selected pressure range. An increase in pressure enhances the fluid density of scCO₂ and thereby strengthens the contact between scCO₂ and samples, whereas the decrease in extraction yields with increasing pressure after a specific point might be attributed to the increasing non-polar nature of the scCO₂ (Jiao & Kermanshahi pour, 2018; Maran et al., 2014).

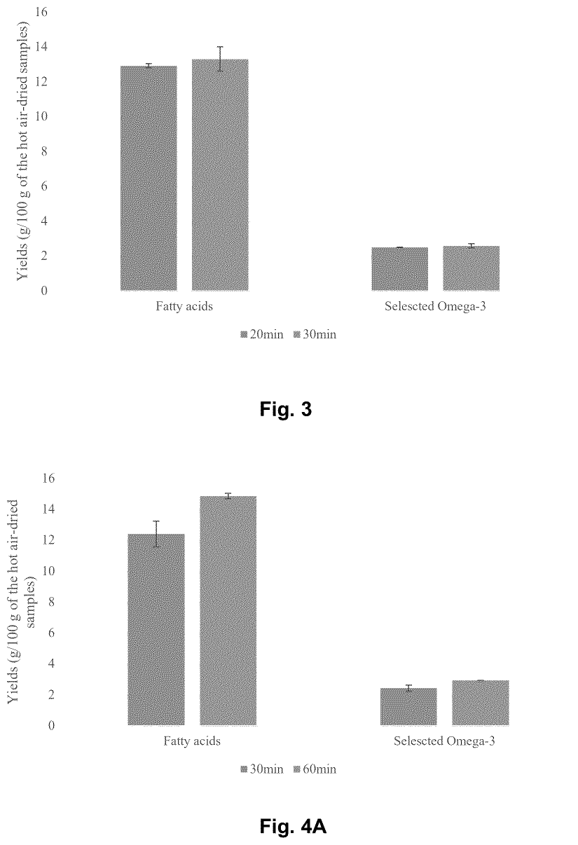

It was observed that by increasing the static extraction time from 0 to 10 to 20 to 30 min, the extracts eluted immediately when the static/dynamic valve and the restrictor valve were opened after the 20 min of soaking. FIG. 3 demonstrates that yields did not change in response to increasing static extraction time from 20 to 30 min. Statistical results also supported this conclusion, revealing no significant changes in yields of fatty acids from 20 to 30 min of static time (p-values >0.05). Thus, the static time of 20 min allows for sufficient contact between samples and scCO₂.

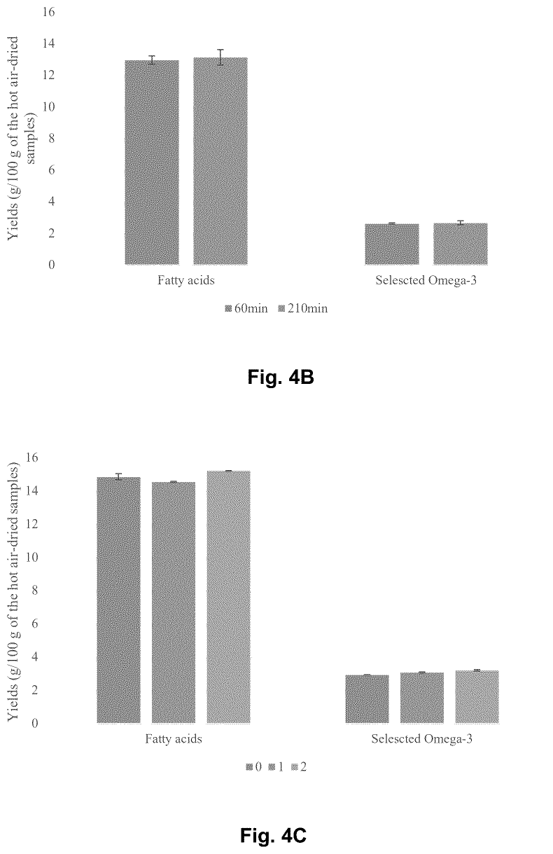

FIGS. 4A-C exhibit that dynamic time did not significantly impact the extraction yields (p-values >0.05), although as dynamic time increased responses rose. Dynamic extraction time might need to be adjusted based on the actual sample weights used; as such, to design more complex models with better predictors (allowed to cover insignificant effects), dynamic extraction time from 30 min to 75 min is selected as a variable to explore the most suitable option.

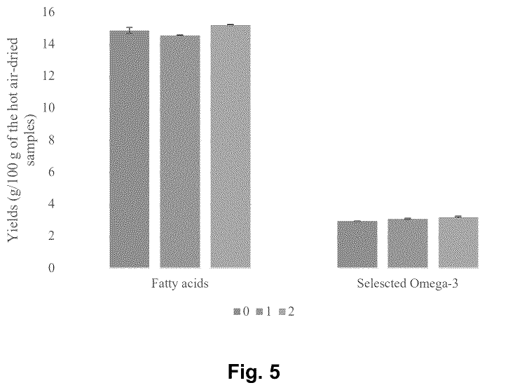

FIG. 5 displays trends of the responses as the mass ratio of co-solvent to biomass increased. One-way ANOVA revealed with the mass ratio of co-solvent to biomass increased from 0:1 to 2:1, significant differences were observed in the yield of selected omega-3 fatty acids (p-value <0.05); whereas a near-marginal significant effect on the total fatty acid yields was found (p-value=0.055>0.05). Nevertheless, the Tukey pairwise comparisons unveiled that increasing the mass ratio of co-solvent to biomass from 1:1 to 2:1 significantly affected the total fatty acids yields (p-value <0.05), and there was no significant difference in increasing the mass ratio from 2:1 to 4:1. That might be because of increasing the polarity of scCO₂ due to the presence of ethanol.

The solubility of target compounds depends on scCO₂ density, which is as a function of temperature and pressure, and the polarity of extraction solvents; as such, the temperature and the mass ratio of co-solvent to biomass may have squared effects or interactions with other factors.

### ScCO₂ Extraction of Cucumaria frondosa Viscera

### Effects of Process Variables on Fatty Acids Yields

Based on the results obtained from the preliminary screening (in the supplementary material), temperature (X₁, 35-75° C.), pressure (X₂, 20-50 MPa), dynamic extraction time (X₃, 30-70 min), and the mass ratio of co-solvent to biomass (X₄, 0-2:1) were used for a response surface design, while static extraction is fixed as 20 min. Table 2 shows the responses studied in scCO₂ extraction of hot air-dried Cucumaria frondosa viscera on the basis of the CCI design. The response surface methodology (RSM) can provide information about the importance and statistical significance of individual factors and was hence used to determine the effects of process variables on the extraction yields.

The full quadratic regression models in uncoded levels for yields of fatty acids and the selected omega-3 fatty acids are shown in Eq. (7) and Eq. (8) with significant terms in bold.

$$Fatty acid yield = - 3.65 - 0.004 {X}_{1} + 0.433 {X}_{2} + 0.176 {X}_{3} + 7.13 {X}_{4} + 0.00 \; 028 {X}_{1}^{2} - 0.00704 {X}_{2}^{2} - 0.000995 {X}_{3}^{2} - 0.098 {X}_{4}^{2} + 0.00316 {X}_{1} {X}_{2} + 0.00002 {X}_{1} {X}_{3} - 0.0721 {X}_{1} {X}_{4} - 0.00119 {X}_{2} {X}_{3} + 0.0108 {X}_{2} {X}_{4} - 0.0384 {X}_{3} {X}_{4} \qquad Eq . ( 7 )$$

$$Selected omega - 3 yields = - 0.44 - 0.0045 {X}_{1} + 0.0924 {X}_{2} + 0.0392 {X}_{3} + 1.051 {X}_{4} + 0.000182 {X}_{1}^{2} - 0.000988 {X}_{2}^{2} - 0.000118 {X}_{3}^{2} - 0.052 {X}_{4}^{2} + 0.000208 {X}_{1} {X}_{2} - 0.000131 {X}_{1} {X}_{3} - 0.00838 {X}_{1} {X}_{4} - 0.000525 {X}_{2} {X}_{3} - 0.0015 {X}_{2} {X}_{4} - 0.00338 {X}_{3} {X}_{4} \qquad Eq . ( 8 )$$

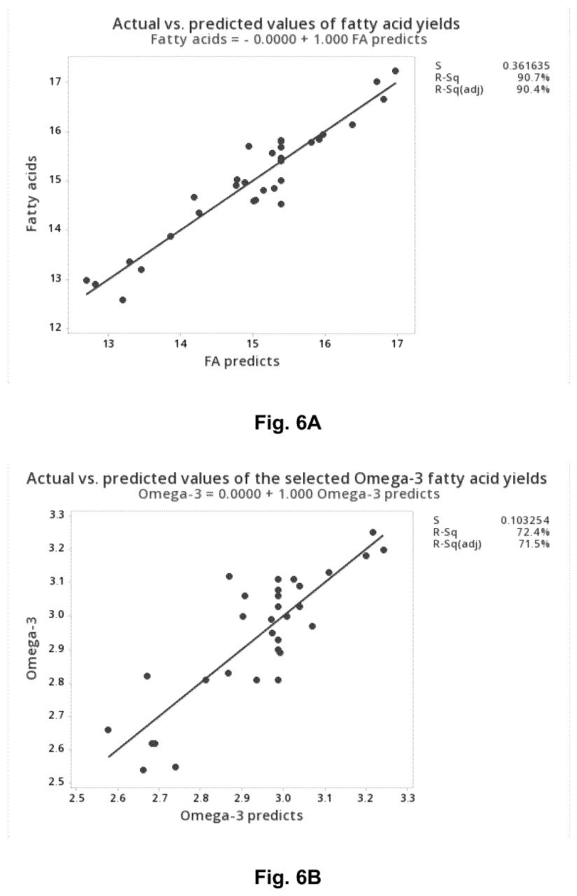

The predicted and the observed experimental results are plotted in FIG. 6. FIG. 6A graphically examines the experimental fatty acids yields well fitted into their corresponding predicted values against the linear regression line, with an R² of 90.7%. However, the regression model for selected omega-3 yields does not cover experimental data sufficiently due to the relatively lower R² resulting from the non-ideal correlation between actual values and predicted values (FIG. 6B). That may be caused by inherent characteristics like very low yields of EPA and DHA introducing more errors into the data collected. Also, fatty acid yields were obtained through a series of operations including extraction, transesterification, and GC analysis; as a result, fatty acid loss or degradation happens easily during the process. The ANOVA for these two responses is presented in Table 3.

TABLE 3
Analysis of variance (ANOVA) for response surface models of fatty acid
yields and the selected omega-3 fatty acid yields (g/100 g of samples
on the dry weight basis). Significant model items are in bold fonts.

| | | | Selected omega-3 | |
|---|---|---|---|---|
| | Fatty acid yields | | fatty acid yields | |
| | Coefficient | P-Value | Coefficient | P-Value |
| Model | | 0.000 | | 0.019 |
| Constant | −3.65 | | −0.44 | |
| Linear | | 0.018 | | 0.201 |
| Temperature | −0.0021 | 0.975 | −0.0022 | 0.908 |
| Pressure | 0.2166 | 0.021 | 0.0462 | 0.074 |
| Dynamic extraction time | 0.0881 | 0.191 | 0.0196 | 0.304 |
| Co-solvent/biomass mass ratio | 3.57 | 0.006 | 0.525 | 0.124 |
| Quadratic | | 0.008 | | 0.274 |
| Temperature*Temperature | 0.00007 | 0.762 | 0.000045 | 0.495 |
| Pressure*Pressure | −0.001759 | 0.000 | −0.000247 | 0.048 |
| Dynamic extraction time*Dynamic extraction time | −0.000249 | 0.291 | −0.00003 | 0.655 |
| Co-solvent/biomass mass ratio*Co-solvent/biomass | −0.0245 | 0.791 | −0.0131 | 0.622 |
| mass ratio | | | | |
| 2-way interaction | | 0.058 | | 0.758 |
| Temperature*Pressure | 0.00079 | 0.069 | 0.000052 | 0.659 |
| Temperature*Dynamic extraction time | 0.000005 | 0.988 | −0.000033 | 0.711 |
| Temperature*Co-solvent/biomass mass ratio | −0.01803 | 0.009 | −0.00209 | 0.246 |
| Pressure*Dynamic extraction time | −0.000298 | 0.473 | −0.000131 | 0.274 |
| Pressure*Co-solvent/biomass mass ratio | 0.00271 | 0.743 | −0.00038 | 0.873 |
| Dynamic extraction time*Co-solvent/biomass mass | −0.00959 | 0.134 | | 0.634 |
| ratio | | | −0.00084 | |
| Lack-of-Fit | | 0.466 | | 0.216 |
| R² | | 90.69% | | 72.45% |

The R² of the models for fatty acid yields is 90.69%, and for the selected omega-3 fatty acid yields is 72.45%. Furthermore, the results exhibit the lack-of-fit of these two models is not significant (0.466 and 0.216, respectively), indicating the precision and reliability of the models. Thus, the regression models of fatty acid yields and the selected omega-3 fatty acid yields established in this study were predictive, qualitative, and evaluative, with relatively satisfactory correlations between responses and process variables. Furthermore, the linear effects of pressure and mass ratio of co-solvent to biomass, the square effects of pressure, and the interactions between temperature and mass ratio of co-solvent to biomass are considered to significantly impact the fatty acid yields, while only the quadratic effects of pressure are regarded as significant model terms for the selected omega-3 fatty acid yields.

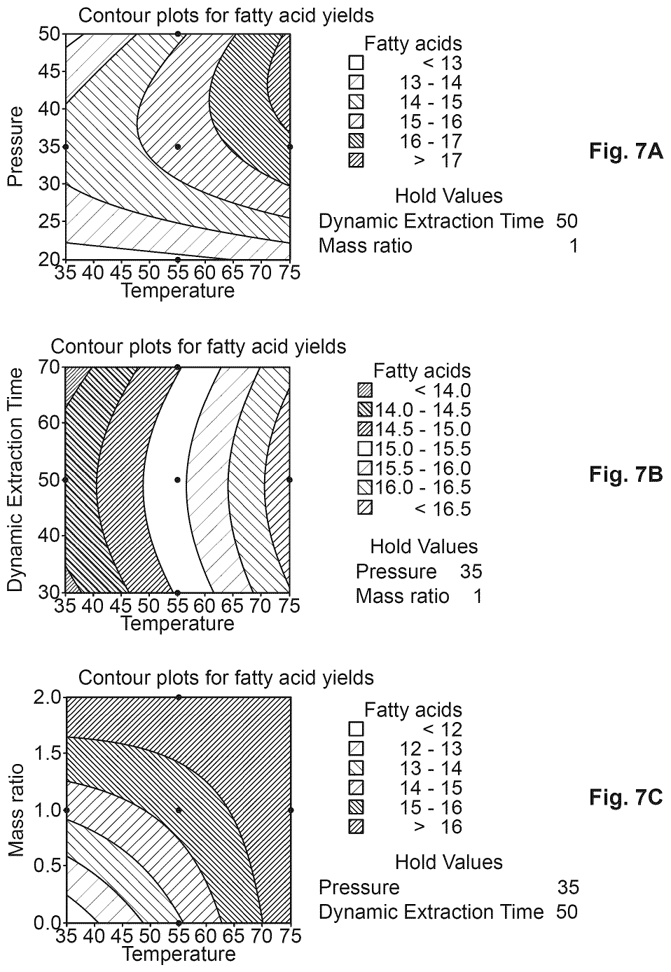

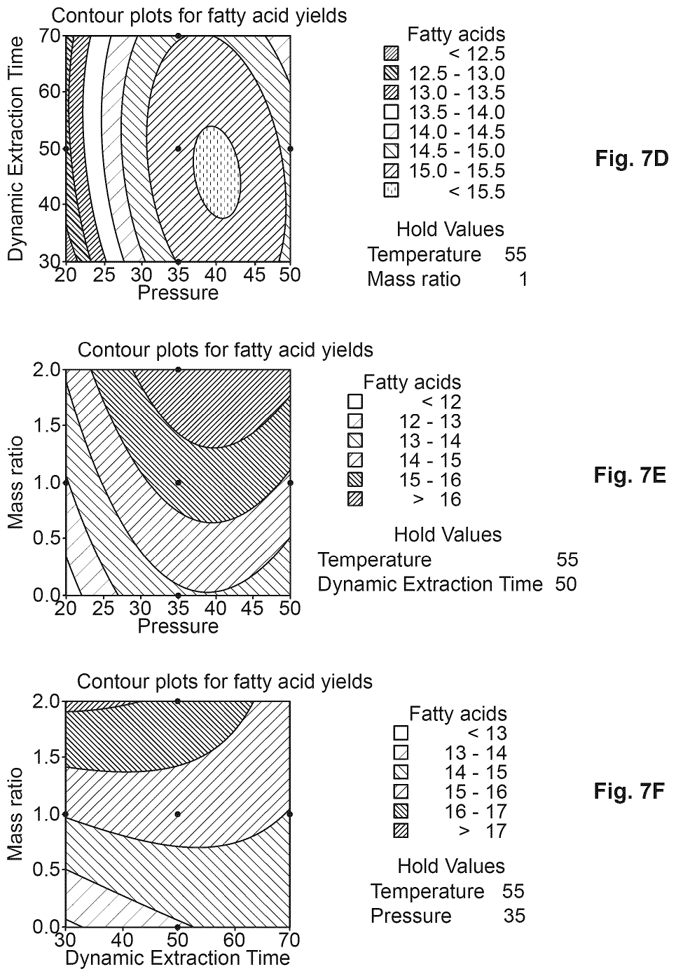

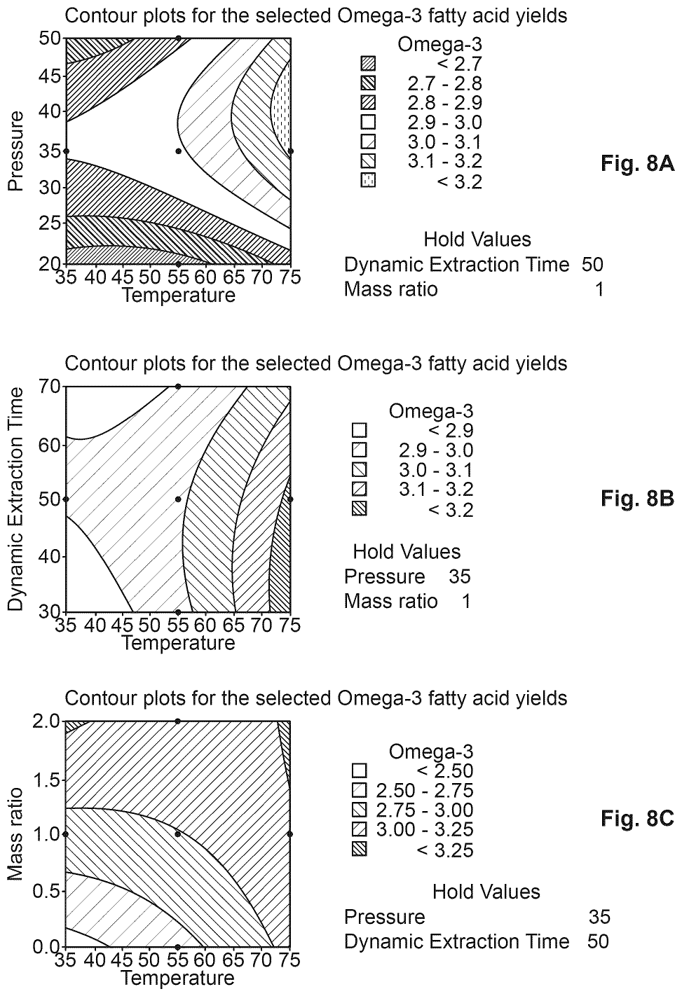

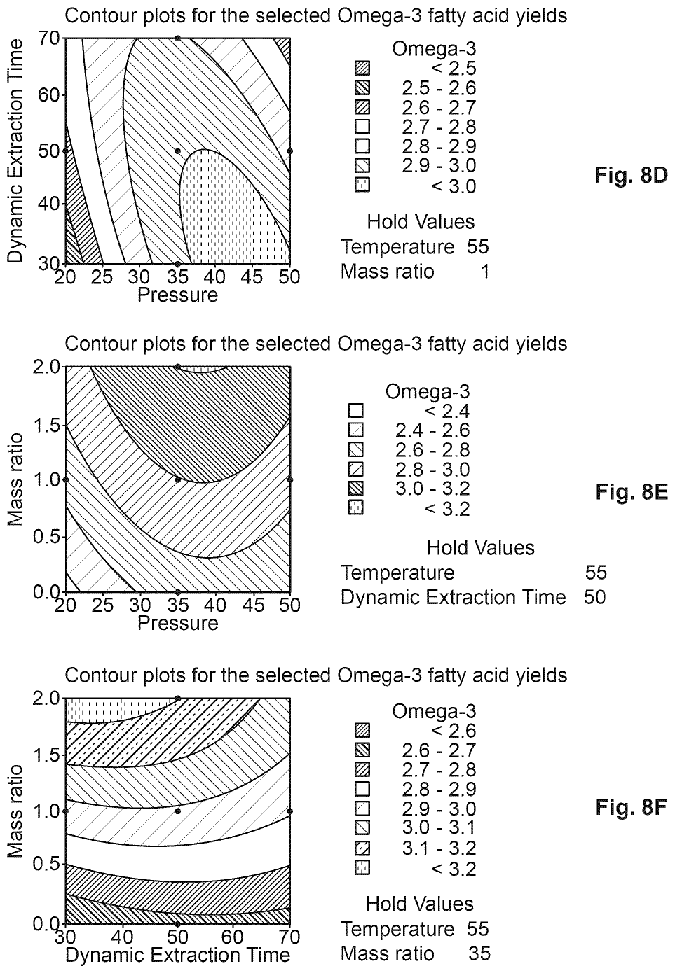

The contour plots of yields of fatty acids and the selected omega-3 fatty acids are shown in FIG. 7 and FIG. 8. In each diagram, two factors were held for a better understanding on how the other two factors interacted. Normally, those non-targeted variables are maintained at their median values, like the temperature of 55° C., the pressure of 35 MPa, the dynamic extraction time of 50 min, and the co-solvent/biomass mass ratio of 1.

It is observed from FIG. 7A and FIG. 8A that the maximum yields of over 17 g of fatty acids and more than 3.2 g of EPA and DHA in 100 g of samples on the dry weight basis can be obtained at a temperature of about 73-75° C. and a pressure of approximately 36-47 MPa with constant dynamic extraction time and co-solvent/biomass mass ratio. Pressure and temperature can directly affect the density of the supercritical fluid. Moderate pressures and higher temperatures may improve the solvating power of the supercritical fluid for fatty acids, leading to an increase in the extraction yields. Moreover, higher temperatures could enhance the intensive thermal motion of compounds to transfer from samples to the supercritical solvents and thus increase the solubility of fatty acids to contribute to higher extraction yields.

FIG. 7B and FIG. 8B show the influences of temperature and dynamic extraction time on the extraction yields. FIG. 7B demonstrates increasing temperature leads to an increase in fatty acid yields at a wide range of dynamic extraction times. FIG. 8B exhibits as long as the dynamic extraction time is shorter than about 52 min, the highest EPA and DHA yields can be obtained as the temperature increases within the coded level.

FIGS. 7C, F and G as well as FIGS. 8C, F and G display the effects of co-solvent on extraction yields, reflecting increasing the co-solvent/biomass mass ratio results in increases in extraction yields. The addition of co-solvent ethanol increases the solubility of polar fatty acids in scCO₂ by enhancing the polarity, strengthens the penetration of scCO₂ into samples increasing the diffusion of fatty acids, and enhances the interaction with samples replacing lipids from the active sites. Therefore, the extraction yields reached the maximum when the co-solvent/biomass mass ratio is 2.

Effects of pressure and dynamic extraction time are plotted in FIG. 7E and FIG. 8E. FIG. 7E shows curvatures in the coded levels, revealing the highest fatty acid yields can be acquired in pressures from about 40-48 MPa and dynamic extraction times from approximately 38-52 min. FIG. 8E shows a curvature in the pressure, indicating as the pressure increases the selected omega-3 fatty acid yields increase and then decrease. The highest EPA and DHA yield can be found when the pressure is higher than about 36 MPa and the dynamic extraction time is shorter than approximately 50 min.

### 3.1.2. Optimization of Fatty Acid Yields

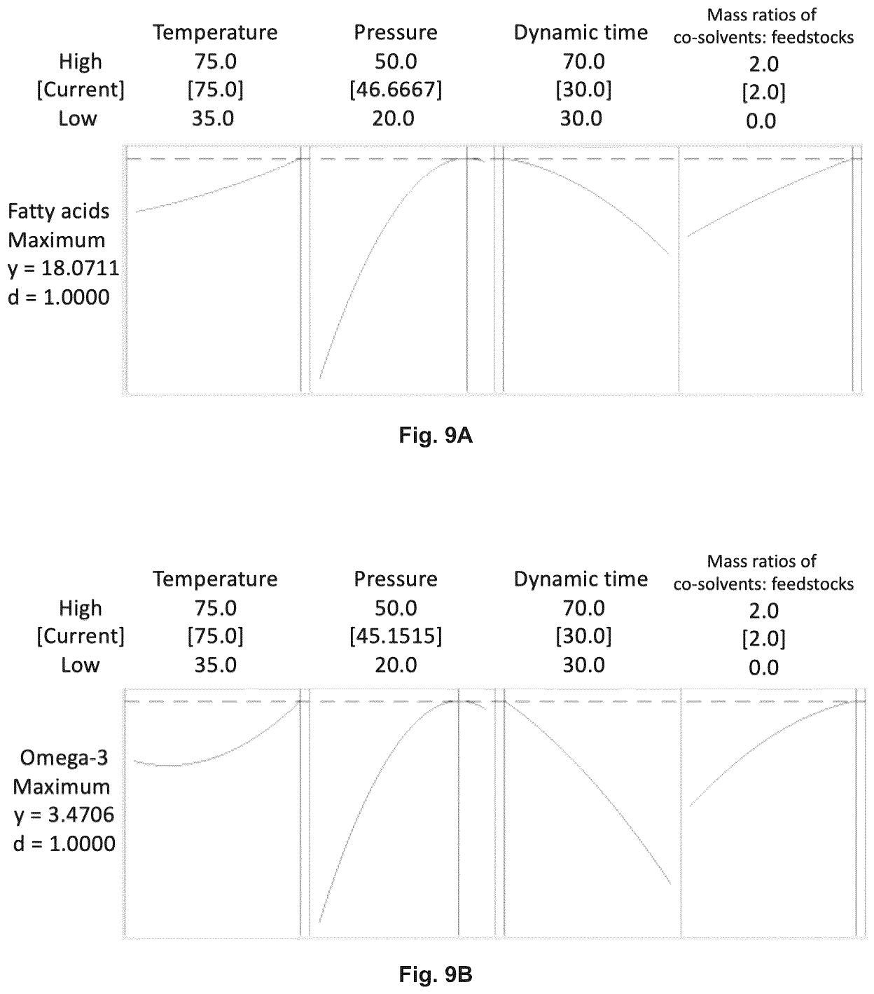

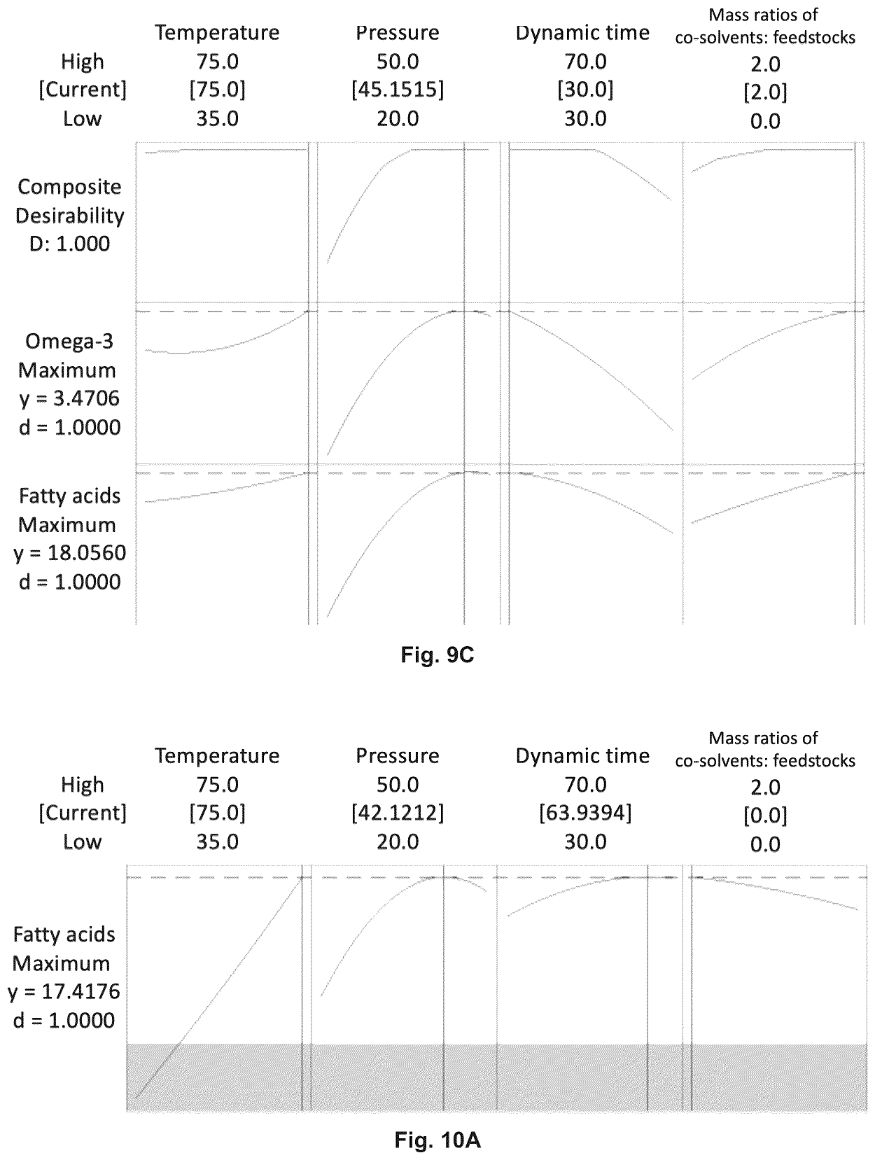

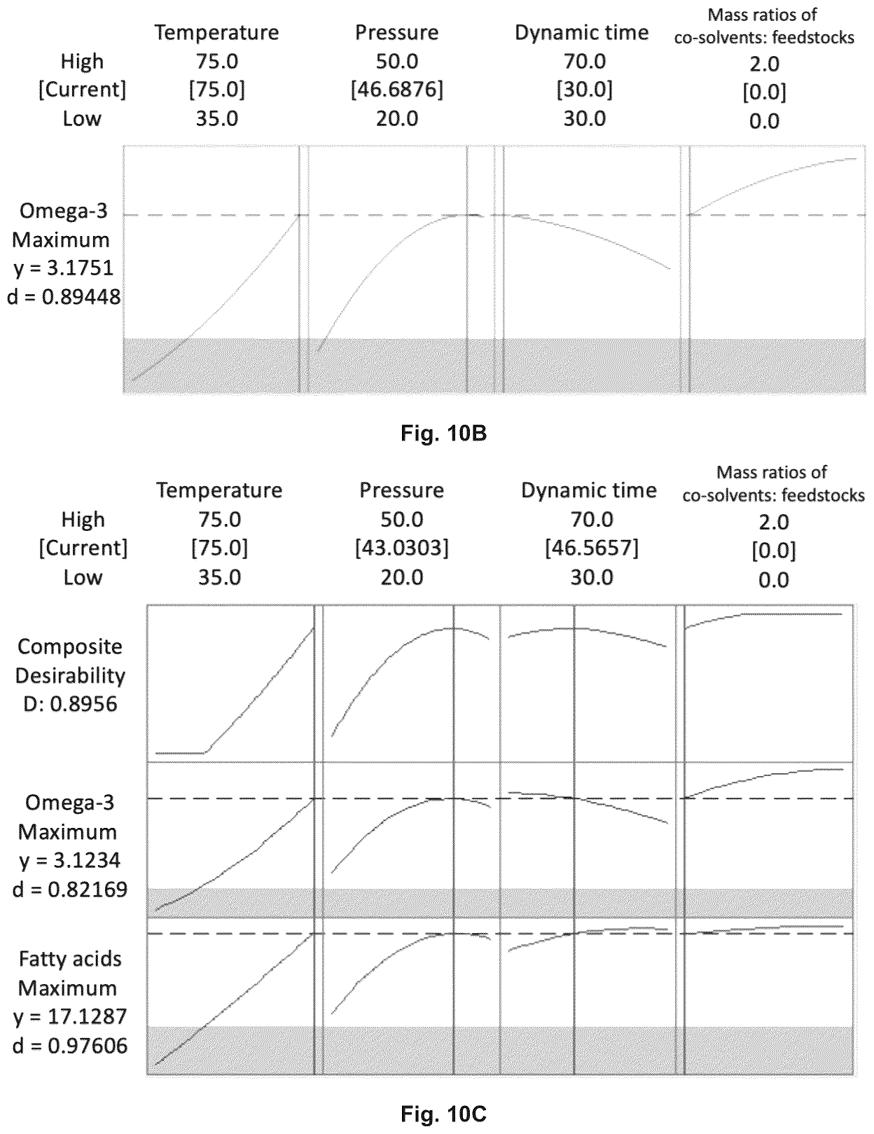

To maximize yields of fatty acids and/or the selected omega-3 fatty acids, the optimal extraction conditions are determined using the response optimizer in Minitab 19.0 and presented in Table 4. The optimization plots for those target compounds are shown in FIGS. 9 and 10. Model validation is also performed under optimal conditions.

TABLE 4
Optimal conditions of scCO₂ extraction of Cucumaria frondosa viscera for maximum
fatty acids and the selected omega-3 fatty acids. The optimal conditions under different
scenarios can be classified as co-solvent added and no co-solvent added.

| | | | | | Predicted product yield interval | |
|---|---|---|---|---|---|---|
| | | | | | (g/100 g of the hot air-dried | |
| | | | | | samples on the dry weight basis) | |
| | Optimal reaction conditions | | | | | The selected |
| | X₁ | X₂ | X₃ | X₄ | | omega-3 fatty |
| Scenario | (° C.) | (MPa) | (min) | (w/w) | Fatty acids | acids |
| Max fatty acids | 75 | 47 | 30 | 2:1 | (15.150, 20.990) | \ |
| | 75 | 42 | 64 | 0:1 | (15.125, 19.710) | \ |
| Max the selected | 75 | 45 | 30 | 2:1 | \ | (2.668, 4.273) |
| omega-3 fatty acids | 75 | 47 | 30 | 0:1 | \ | (2.342, 4.008) |
| Max all responses | 75 | 45 | 30 | 2:1 | (15.240, 20.870) | (2.668, 4.273) |
| | 75 | 44 | 41 | 0:1 | (14.744, 19.091) | (2.524, 3.765) |

In comparison of these three scenarios, temperature of 75° C., pressure of 45 MPa, dynamic extraction time of 30 min, and mass ratio of ethanol/biomass of 2:1 is suggested as the preferred setting for maximizing yields of all responses. Extraction without introducing co-solvents may ultimately be preferred at the commercial level to avoid an additional purification step. Accordingly, a mass ratio of co-solvent:biomass held at a value of 0 is also considered in the optimization.

Experiments under the optimal conditions with/without the co-solvent that maximize yields of fatty acids and the selected omega-3 fatty acids were carried out in duplicate and summarized in Table 5. The experimental results reveal the differences between fatty acids yields and the selected omega-3 yields from these two suggested conditions are big enough to be statistically significant. The statistical results are consistent with the ANOVA of the generated models, in which the co-solvent to biomass mass ratio-related linear term is statistically significant in the fatty acids regression model. The acquired experimental yields of fatty acids and the selected omega-3 fatty acids all fell in the 95% predicted intervals; as such, a good agreement between experimental values and model-determined values has been obtained, reemphasizing that the generated models are reliable. Moreover, the weight percent of the selected omega-3 fatty acids in the total fatty acids under these two situations is (20.710±0.448) % and (19.4010.118) % and they are significantly different. Therefore, from the perspective of yields and composition, the preferred condition is temperature of 75° C., pressure of 45 MPa, a static extraction time of 20 min followed by dynamic extraction time of 30 min, and mass ratio of ethanol/biomass of 2:1, but to make a decision for the incorporation of co-solvent in actual practice at a commercial level will require a techno-economic analysis.

TABLE 5
Experimental yields of fatty acids and the selected omega-3
(g/100 g of the hot air-dried samples on the dry weight basis)
under optimal conditions with/without co-solvents added
(n = 4, Mean ± SD). Values in the same column with
different letters are significantly different at P < 0.05.

| | | | Selected |
|---|---|---|---|
| | | | omega-3 |
| | | Fatty acids | fatty acids |
| Optimal conditions | | yields | yields |
| Temperature of 75° C., pressure | Experimental | 16.304 ± | 3.378 ± |
| of 45 MPa, dynamic extraction | value | 0.658^{a} | 0.204^{a} |
| time of 30 min, and co-solvent | Predicted value | 18.060 | 3.471 |
| to biomass mass ratio of 2:1 | Predicted | (15.240, | (2.668, |
| | interval | 20.870) | 4.273) |
| | Recovery %¹ | 73.554 | 81.673 |
| Temperature of 75° C., pressure | Experimental | 14.860 ± | 2.883 ± |
| of 44 MPa, dynamic extraction | value | 0.078^{b} | 0.033^{b} |
| time of 41 min, and co-solvent | Predicted value | 16.918 | 3.143 |
| to biomass mass ratio of 0:1 | Predicted | (14.744, | (2.524, |
| | interval | 19.091) | 3.765) |
| | Recovery %¹ | 67.040 | 69.705 |

¹recovery efficiencies are calculated as the ratio of the experimental value to the maximum contents of fatty acids obtained from in-situ transesterification of freeze-dried samples (22.166 g/100 g of samples on the dry weight basis).

In the coded levels, the highest fatty acid yields and the selected omega-3 fatty acid yields were obtained under the temperatures of 65° C. and 75° C., respectively. Although a study mentioned the main omega-3 fatty acids, EPA, and DHA, were significantly degraded at 50° C. or above (Hadaruga et al., 2016, Beilstein Journal of organic Chemistry, 12, 179-191), this was not observed.

3.2. Comparison Between Conventional and scCO₂ Methods

Conventional extraction based on the Bligh & Dyer method and the in-situ transesterification was conducted and the extraction yields of fatty acids and the selected omega-3 fatty acids are compared with those of scCO₂ extraction with the preferred conditions as defined herein to gain deeper insights on scCO₂ extraction of fatty acids from sea cucumber by-products. As shown in Table 6, the fatty acid yields of scCO₂ extraction of Cucumaria frondosa viscera are comparable with the fatty acid amount observed in in-situ transesterification and the ultrasonic-assisted in-situ transesterification, and the Selected omega-3 fatty acid yields of scCO₂ extraction are comparable with those of the ultrasonic-assisted Bligh & Dyer method and in-situ transesterification. Overall, processing of hot air-dried Cucumaria frondosa viscera using in-situ transesterification and scCO₂ extraction led to similar yields of fatty acids, EPA, and DHA.

However, the Bligh & Dyer method extracted significantly more crude oils due to the co-extraction of some untargeted compounds, reflecting that scCO₂ extraction had higher selectivity to fatty acids. Notably, the ultrasonic pre-treatment shows Improvements in the conventional extraction of fatty acids. Without being bound by theory, that might be because the ultrasonication disrupted cells, resulting in the extraction of additional different fatty acids.

TABLE 6
A comparison of fatty acid yields and the selected omega-3 fatty
acid yields of hot air-dried Cucumaria frondosa viscera that
are obtained from the Bligh & Dyer method (n = 4, Mean ±
SD), in-situ transesterification (n = 4, Mean ± SD), and
scCO₂ extraction under the optimal condition (n = 4,
Mean ± SD). Values in the same column with different
letters are significantly different at P < 0.05.

| | | Selected omega-3 |
|---|---|---|
| Methods | Fatty acids | fatty acids |
| The Bligh & Dyer | 9.016 ± 1.545^{a} | 2.216 ± 0.340^{a} |
| Ultrasonic-assisted Bligh & Dyer | 13.594 ± 0.795^{b} | 3.156 ± 0.182^{b} |
| In-situ transesterification | 15.942 ± 0.349^{c} | 3.717 ± 0.150^{cd} |
| Ultrasonic-assisted in-situ | 17.428 ± 0.201^{c} | 3.923 ± 0.050^{d} |
| transesterification | | |
| scCO₂ extraction | 16.304 ± 0.658^{c} | 3.378 ± 0.204^{bc} |

The fatty acids composition (weight percentage in the total fatty acids) of the extract of Cucumaria frondosa viscera obtained from the ultrasonic-assisted Bligh & Dyer method, the ultrasonic-assisted in-situ transesterification, and scCO₂ extraction are compared in Table 7.

TABLE 7
The fatty acid profiles (weight percentage in the total fatty acids) of the global extract of hot air-dried Cucumaria frondosa
viscera obtained from the ultrasonic-assisted Bligh & Dyer method, the ultrasonic-assisted in-situ transesterification, and
scCO2 extraction (n = 4, Mean ± SD). Values in the same row with different letters are significantly different at p < 0.05.

| Type | Isomer | Systematic name | Bligh & Dyer | In-situ | ScCO₂ |
|---|---|---|---|---|---|
| Saturated | C14:0 | Myristic acid | 1.744 ± 0.009 | 1.869 ± 0.018 | 1.997 ± 0.042 |
| | C15:0 | Pentadecylic acid | 2.476 ± 0.002 | 2.544 ± 0.017 | 2.766 ± 0.064 |
| | C16:0 | Palmitic acid | 1.443 ± 0.003 | 1.433 ± 0.013 | 1.515 ± 0.046 |
| | C17:0 | Heptadecanoic acid | 0.267 ± 0.012 | 0.297 ± 0.011 | 0.301 ± 0.028 |
| | C18:0 | Stearic acid | 2.990 ± 0.017 | 2.803 ± 0.028 | 2.627 ± 0.014 |
| | C20:0 | Arachidic acid | 0.531 ± 0.011 | 0.500 ± 0.003 | 0.520 ± 0.209 |
| | C21:0 | Henicosanoic acid | 0.196 ± 0.003 | 0.192 ± 0.003 | 0.159 ± 0.010 |
| | C22:0 | Behenic acid | 0.619 ± 0.011 | 0.527 ± 0.020 | 0.475 ± 0.015 |
| Total | | | 10.266 ± 0.033^{a} | 10.165 ± 0.092^{a} | 10.360 ± 0.320^{a} |
| Monounsaturated | C16:1n7 | Palmitoleic acid | 16.514 ± 0.061 | 16.845 ± 0.152 | 17.840 ± 0.176 |
| | C17:1 | 10-Heptadecenoic acid | 0.438 ± 0.004 | 0.446 ± 0.011 | 0.476 ± 0.004 |
| | C18:1n9 cis | Oleic acid | 1.302 ± 0.005 | 1.305 ± 0.009 | 1.293 ± 0.011 |
| | C18:1n7 | Vaccenic acid | 2.903 ± 0.002 | 2.899 ± 0.020 | 2.830 ± 0.025 |
| | C20:1n9 | 11-Eicosenoic acid | 0.544 ± 0.014 | 0.544 ± 0.003 | 0.490 ± 0.020 |
| | C22:1n9 | Erucic acid | 0.502 ± 0.017 | 0.53 ± 0.028 | 0.443 ± 0.015 |
| | C24:1n9 | Nervonic acid | 1.857 ± 0.036 | 1.727 ± 0.019 | 1.572 ± 0.083 |
| Total | | | 24.061 ± 0.030^{a} | 24.297 ± 0.214^{a} | 24.944 ± 0.080^{b} |
| Polyunsaturated | C16:2n4 | Hexadecadienoic acid | 0.928 ± 0.035 | 1.014 ± 0.032 | 1.032 ± 0.059 |
| | C18:2n6 trans | Linolelaidic acid | 0.119 ± 0.001 | 0.134 ± 0.001 | 0.125 ± 0.006 |
| | C18:2n6 cis | Linoleic acid | 0.279 ± 0.000 | 0.276 ± 0.003 | 0.271 ± 0.003 |
| | C18:2n4 | 11,14-Octadecadienoic acid | 0.469 ± 0.002 | 0.473 ± 0.004 | 0.456 ± 0.004 |
| | C20:2n6 | 11,14-eicosadienoic acid | 0.269 ± 0.001 | 0.283 ± 0.005 | 0.197 ± 0.012 |
| | C22:2n6 | 13,16-Docosadienoic acid | 0.112 ± 0.004 | 0.138 ± 0.005 | 0.118 ± 0.015 |
| | C16:3n4 | 6,9,12-hexadecatrienoic acid | 0.418 ± 0.006 | 0.437 ± 0.012 | 0.453 ± 0.012 |
| | C18:3n4 | 8,11,14-octadecatrienoic acid | 0.101 ± 0.010 | 0.098 ± 0.001 | 0.101 ± 0.008 |
| | C18:3n3 | α-Linolenic acid (ALA) | 0.121 ± 0.023 | 0.146 ± 0.001 | 0.137 ± 0.086 |
| | C16:4n1 | 6,9,12, 15-hexadecatetraenoic acid | 1.223 ± 0.005 | 1.257 ± 0.011 | 1.282 ± 0.009 |
| | C18:4n3 | Stearidonic acid | 0.836 ± 0.003 | 0.891 ± 0.047 | 0.723 ± 0.209 |
| | C20:4n6 | Arachidonic acid | 0.571 ± 0.002 | 0.598 ± 0.005 | 0.463 ± 0.084 |
| | C20:4n3 | Eicosatetraenoic acid (ETA) | 0.278 ± 0.010 | 0.297 ± 0.008 | 0.205 ± 0.018 |
| | C20:5n3 | Eicosapentaenoic acid (EPA) | 22.486 ± 0.043^{a} | 21.735 ± 0.199^{b} | 19.834 ± 0.478^{c} |
| | C21:5n3 | Heneicosapentaenoic acid (HPA) | 0.393 ± 0.031 | 0.366 ± 0.003 | 0.626 ± 0.011 |
| | C22:5n3 | Docosapentaenoic acid (DPA) | 0.278 ± 0.004 | 0.284 ± 0.002 | 0.217 ± 0.034 |
| | C22:6n3 | Docosahexaenoic acid (DHA) | 1.231 ± 0.015 | 0.876 ± 0.006 | 0.876 ± 0.043 |
| Total of Omega-3 | | | 25.623 ± 0.103^{a} | 24.594 ± 0.254^{b} | 22.619 ± 0.838^{c} |
| Total of Omega-6 | | | 1.350 ± 0.004^{a} | 1.429 ± 0.012^{a} | 1.174 ± 0.097^{b} |
| Total | | | 30.112 ± 0.071^{a} | 29.302 ± 0.300^{a} | 27.116 ± 0.938^{b} |
| Branched | 4,8,12-Me-13:0 | 4,8,12-Trimethyltridecanoic acid | 2.475 ± 0.005 | 2.576 ± 0.023 | 2.818 ± 0.068 |
| | Me-14:0 isomer 1 | Methyltridecanoic acid | 0.466 ± 0.002 | 0.581 ± 0.004 | 0.583 ± 0.044 |
| | Me-14:0 isomer 2 | | 0.414 ± 0.023 | 0.411 ± 0.004 | 0.455 ± 0.011 |
| | Me-14:0 isomer 3 | | 0.377 ± 0.001 | 0.382 ± 0.003 | 0.409 ± 0.007 |
| | i-16:0 | 14-methylpentadecanoic acid | 4.349 ± 0.010 | 4.399 ± 0.034 | 4.762 ± 0.086 |
| | i-17:0 | 15-methylhexadecanoic acid | 0.289 ± 0.008 | 0.379 ± 0.011 | 0.269 ± 0.004 |
| | ai-15:0 | 12-methyltetradecanoic acid | 21.346 ± 0.029^{a} | 22.062 ± 0.203^{a} | 24.173 ± 0.598^{b} |
| | ai-17:0 | 14-methylhexadecanoic acid | 0.866 ± 0.024 | 0.823 ± 0.018 | 0.956 ± 0.061 |
| Total | | | 30.582 ± 0.036^{a} | 31.614 ± 0.283^{b} | 34.426 ± 0.699^{c} |
| Others¹ | | | 4.980 ± 0.026^{a} | 5.062 ± 0.039^{a} | 3.154 ± 0.130^{b} |

¹Others refer to fatty acid isomers presented in the sample GC chromatograph.

The fatty acids composition of these three methods was significantly different, but EPA, palmitoleic acid (C16:1n7), and 12-methyltetradecanoic acid (12-MTA) were the major fatty acids. As for the Bligh & Dyer method, EPA was the predominant fatty acid with 22.486%, while 12-MTA was the leading fatty acid with 22.062% and 24.173% respectively in in-situ transesterification and scCO₂ extraction. The weight percent of EPA in the total fatty acids obtained from in-situ transesterification and scCO₂ extraction was 21.735% and 19.834%, accordingly. Limited research done on the identification of FAMEs present in sea cucumbers found the presence of branched fatty acid 12-MTA. 12-MTA can be used for tumour cell treatment individually or in combination with other nutritional or anti-cancer compounds through inducing cell apoptosis-related metabolites or activities in the cancer proliferation.

### 3.3. Effects of Pre-Treatments on Fatty Acid Yields

### 3.3.1. Effects of Different Drying Methods

Fresh, freeze-dried, and hot air-dried samples were subjected to scCO₂ extraction under the preferred conditions in duplicate. The transesterified extracts were analyzed by GC-FID. The yields of the total fatty acids and the selected omega-3 fatty acids on the dry weight basis presented in Table 8 revealed pre-treatments affected responses significantly with p-values far smaller than 0.05 (p-values=0.000<0.05); among which, freeze-dried samples yielded significantly more fatty acids and the selected omega-3 fatty acids, while samples without any pre-treatments resulted in the most minor yields.

TABLE 8
Experimental yields (g/100 g of samples on the dry weight basis) of the
total fatty acids and the selected omega-3 fatty acids under the preferred condition
of scCO₂ extraction (n = 4/n = 3 for EtOH soaking, Mean ±
SD). Samples underwent different pre-treatments, and the Tukey test compared
the experimental yields at a 95% confidence level. Values in the same column
with different letters are significantly different at p < 0.05.

| | Fatty acid | | Selected omega-3 | |
|---|---|---|---|---|
| Pre-treatment | yields | Recovery % | yields | Recovery % |
| Fresh samples | 5.144 ± 0.483^{a} | 23.207 | 1.333 ± 0.184^{a} | 32.229 |
| Hot air dry | 16.304 ± 0.658^{b} | 73.554 | 3.378 ± 0.204^{b} | 81.673 |
| Freeze dry | 21.369 ± 1.064^{c} | 96.404 | 4.267 ± 0.286^{c} | ~100 |
| Fresh + EtOH | 13.683 ± 0.643^{d} | 61.730 | 3.466 ± 0.093^{b} | 83.801 |
| Hot air dry + EtOH | 16.563 ± 0.324^{b} | 74.723 | 3.689 ± 0.109^{b} | 89.192 |

The results were consistent with the fatty acid contents of those samples obtained from the ultrasonic-assisted in-situ transesterification besides the selected omega-3 fatty acid contents of hot air-dried and freeze-dried samples (Table 9). The moisture contents of fresh, freeze-dried, and hot air-dried samples are presented in Table 9.

TABLE 9
Ultrasonic-assisted in-situ transesterification of fresh, hot air-
dried, and freeze-dried samples (n = 4, Mean ± SD), with
contents of fatty acids and omega-3 fatty acids (g/100 g of samples
on the dry weight basis) and moisture (%). Values in the same column
with different letters are significantly different at p < 0.05.

| | | Fatty acid | Selected omega-3 |
|---|---|---|---|
| Pre-treatment | Moisture contents | contents | contents |
| Fresh samples | 83.204 ± 0.095^{a} | 5.089 ± 0.691^{a} | 1.671 ± 0.246^{a} |
| Hot air dry | 6.445 ± 0.027^{b} | 17.428 ± 0.201^{b} | 3.923 ± 0.050^{b} |
| Freeze dry | 2.646 ± 0.116^{c} | 22.166 ± 0.730^{c} | 4.136 ± 0.060^{b} |

Compared fatty acid yields of scCO₂ extraction of samples subject to different pre-treatments with the fatty acid contents obtained from the ultrasonic-assisted in-situ transesterification of freeze-dried samples (Table 8), almost all fatty acids (96.404%) and similar amounts of EPA and DHA were recovered in scCO₂ extraction of freeze-dried samples, but scCO₂ extraction of hot air-dried samples performed averagely with 73.554% of fatty acid recovery and 81.673% of EPA and DHA recovery, and only 23.207% of fatty acids and 32.229% of the selected omega-3 fatty acids were recovered in fresh samples. Without wishing to be bound by theory, that might be because the higher moisture content hindered the penetration of scCO₂ for the extraction of more fatty acids. However, the difference between the selected omega-3 fatty acid content obtained from ultrasonic-assisted in-situ transesterification of the freeze-dried samples (4.136±0.060) and the selected omega-3 fatty acid yields of scCO₂ extraction of the freeze-dried samples (4.267±0.286) was not big enough to be statistically significant; as such, it could not be concluded that scCO₂ extraction of the freeze-dried samples recovered almost all EPA and DHA.

Table 10 compares the fatty acids profiles of the oil extracted by scCO₂ from samples that underwent different pre-treatments.

TABLE 10
The fatty acid profiles (weight percentage in the total fatty acids, n = 4, Mean ± SD) of the global
extract of Cucumaria frondosa viscera obtained from scCO₂ extraction under the optimal condition. Viscera underwent
different pre-treatments. Values in the same row with different letters are significantly different at p < 0.05.

| Type | Isomer | Systematic name | Fresh | Hot air dry | Freeze dry |
|---|---|---|---|---|---|
| Saturated | C14:0 | Myristic acid | 3.238 ± 0.316 | 1.997 ± 0.042 | 2.173 ± 0.034 |
| | C15:0 | Pentadecylic acid | 1.321 ± 0.153 | 2.766 ± 0.064 | 2.345 ± 0.040 |
| | C16:0 | Palmitic acid | 2.324 ± 0.149 | 1.515 ± 0.046 | 1.556 ± 0.038 |
| | C17:0 | Heptadecanoic acid | 0.326 ± 0.051 | 0.301 ± 0.028 | 0.148 ± 0.003 |
| | C18:0 | Stearic acid | 3.223 ± 0.227 | 2.627 ± 0.014 | 1.963 ± 0.033 |
| | C20:0 | Arachidic acid | 0.496 ± 0.038 | 0.520 ± 0.209 | 0.339 ± 0.009 |
| | C21:0 | Henicosanoic acid | 0.207 ± 0.013 | 0.159 ± 0.010 | 0.149 ± 0.003 |
| | C22:0 | Behenic acid | 0.514 ± 0.064 | 0.475 ± 0.015 | 0.351 ± 0.012 |
| Total | | | 11.649 ± 0.466^{a} | 10.360 ± 0.320^{b} | 8.987 ± 0.111^{c} |
| Monounsaturated | C16:1n7 | Palmitoleic acid | 19.194 ± 0.704 | 17.840 ± 0.176 | 20.779 ± 0.409 |
| | C17:1 | 10-Heptadecenoic acid | 0.365 ± 0.039 | 0.476 ± 0.004 | 0.445 ± 0.011 |
| | C18:1n9 cis | Oleic acid | 2.160 ± 0.023 | 1.293 ± 0.011 | 1.516 ± 0.045 |
| | C18:1n7 | Vaccenic acid | 3.520 ± 0.162 | 2.830 ± 0.025 | 2.749 ± 0.072 |
| | C20:1n9 | 11-Eicosenoic acid | 0.780 ± 0.034 | 0.490 ± 0.020 | 0.527 ± 0.030 |
| | C22:1n9 | Erucic acid | 0.670 ± 0.073 | 0.443 ± 0.015 | 0.412 ± 0.024 |
| | C24:1n9 | Nervonic acid | 1.799 ± 0.256 | 1.572 ± 0.083 | 1.260 ± 0.110 |
| Total | | | 28.488 ± 0.319^{ac} | 24.944 ± 0.080^{b} | 27.686 ± 0.687^{c} |
| Polyunsaturated | C16:2n4 | Hexadecadienoic acid | 1.011 ± 0.136 | 1.032 ± 0.059 | 0.767 ± 0.014 |
| | C18:2n6 trans | Linolelaidic acid | 0.105 ± 0.007 | 0.125 ± 0.006 | 0.072 ± 0.005 |
| | C18:2n6 cis | Linoleic acid | 0.365 ± 0.034 | 0.271 ± 0.003 | 0.280 ± 0.007 |
| | C18:2n4 | 11,14-Octadecadienoic acid | 0.388 ± 0.015 | 0.456 ± 0.004 | 0.361 ± 0.033 |
| | C20:2n6 | 11,14-eicosadienoic acid | 0.263 ± 0.020 | 0.197 ± 0.012 | 0.169 ± 0.003 |
| | C22:2n6 | 13,16-Docosadienoic acid | 0.161 ± 0.006 | 0.118 ± 0.015 | 0.160 ± 0.027 |
| | C16:3n4 | 6,9,12-hexadecatrienoic acid | 0.647 ± 0.019 | 0.453 ± 0.012 | 0.431 ± 0.017 |
| | C18:3n4 | 8,11,14-octadecatrienoic acid | 0.121 ± 0.012 | 0.101 ± 0.008 | 0.098 ± 0.008 |
| | C18:3n3 | α-Linolenic acid (ALA) | 0.187 ± 0.010 | 0.137 ± 0.086 | 0.113 ± 0.056 |
| | C16:4n1 | 6,9,12,15-hexadecatetraenoic acid | 2.272 ± 0.112 | 1.282 ± 0.009 | 1.400 ± 0.076 |
| | C18:4n3 | Stearidonic acid | 1.117 ± 0.026 | 0.723 ± 0.209 | 0.688 ± 0.035 |
| | C20:4n6 | Arachidonic acid | 0.563 ± 0.088 | 0.463 ± 0.084 | 0.326 ± 0.019 |
| | C20:4n3 | Eicosatetraenoic acid (ETA) | 0.278 ± 0.040 | 0.205 ± 0.018 | 0.185 ± 0.005 |
| | C20:5n3 | Eicosapentaenoic acid (EPA) | 24.587 ± 1.185^{a} | 19.834 ± 0.478^{bc} | 18.616 ± 1.455^{c} |
| | C21:5n3 | Heneicosapentaenoic acid (HPA) | 0.792 ± 0.102 | 0.626 ± 0.011 | 0.585 ± 0.123 |
| | C22:5n3 | Docosapentaenoic acid (DPA) | 0.308 ± 0.067 | 0.217 ± 0.034 | 0.166 ± 0.014 |
| | C22:6n3 | Docosahexaenoic acid (DHA) | 1.245 ± 0.107 | 0.876 ± 0.043 | 0.847 ± 0.067 |
| Total of Omega-3 | | | 28.514 ± 1.304^{a} | 22.619 ± 0.838^{bc} | 21.198 ± 1.604^{b} |
| Total of Omega-6 | | | 1.458 ± 0.097^{a} | 1.174 ± 0.097^{b} | 1.007 ± 0.036^{c} |
| Total | | | 34.411 ± 1.380^{a} | 27.116 ± 0.938^{bc} | 25.262 ± 1.727^{b} |
| Branched | 4,8,12-Me-13:0 | 4,8,12-Trimethyltridecanoic acid | 1.978 ± 0.148 | 2.818 ± 0.068 | 2.421 ± 0.041 |
| | Me-14:0 isomer 1 | Methyltridecanoic acid | 0.400 ± 0.027 | 0.583 ± 0.044 | 0.609 ± 0.050 |
| | Me-14:0 isomer 2 | | 0.303 ± 0.031 | 0.455 ± 0.011 | 0.518 ± 0.009 |
| | Me-14:0 isomer 3 | | 0.160 ± 0.030 | 0.409 ± 0.007 | 0.336 ± 0.007 |
| | i-16:0 | 14-methylpentadecanoic acid | 2.216 ± 0.245 | 4.762 ± 0.086 | 3.887 ± 0.084 |
| | i-17:0 | 15-methylhexadecanoic acid | 0.166 ± 0.016 | 0.269 ± 0.004 | 0.273 ± 0.004 |
| | ai-15:0 | 12-methyltetradecanoic acid | 14.778 ± 1.228^{a} | 24.173 ± 0.598^{b} | 26.757 ± 0.492^{c} |
| | ai-17:0 | 14-methylhexadecanoic acid | 0.900 ± 0.122 | 0.956 ± 0.061 | 0.763 ± 0.031 |
| Total | | | 20.901 ± 1.667^{a} | 34.426 ± 0.699^{bd} | 35.564 ± 0.700^{b} |
| Others¹ | | | 4.551 ± 0.577^{a} | 3.154 ± 0.130^{bc} | 2.464 ± 0.242^{c} |

| | | | | Hot air dry + |
|---|---|---|---|---|
| Type | Isomer | Systematic name | Fresh + EtOH | EtOH |
| Saturated | C14:0 | Myristic acid | 2.619 ± 0.005 | 1.861 ± 0.013 |
| | C15:0 | Pentadecylic acid | 1.544 ± 0.007 | 2.599 ± 0.016 |
| | C16:0 | Palmitic acid | 2.020 ± 0.015 | 1.464 ± 0.005 |
| | C17:0 | Heptadecanoic acid | 0.265 ± 0.010 | 0.289 ± 0.019 |
| | C18:0 | Stearic acid | 2.634 ± 0.064 | 2.786 ± 0.039 |
| | C20:0 | Arachidic acid | 0.486 ± 0.014 | 0.473 ± 0.008 |
| | C21:0 | Henicosanoic acid | 0.229 ± 0.012 | 0.181 ± 0.003 |
| | C22:0 | Behenic acid | 0.536 ± 0.020 | 0.581 ± 0.010 |
| Total | | | 10.332 ± 0.092^{b} | 10.234 ± 0.019^{b} |
| Monounsaturated | C16:1n7 | Palmitoleic acid | 19.668 ± 0.066 | 17.130 ± 0.051 |
| | C17:1 | 10-Heptadecenoic acid | 0.385 ± 0.002 | 0.460 ± 0.005 |
| | C18:1n9 cis | Oleic acid | 2.096 ± 0.024 | 1.328 ± 0.003 |
| | C18:1n7 | Vaccenic acid | 3.183 ± 0.021 | 2.953 ± 0.027 |
| | C20:1n9 | 11-Eicosenoic acid | 0.774 ± 0.024 | 0.519 ± 0.005 |
| | C22:1n9 | Erucic acid | 0.672 ± 0.016 | 0.526 ± 0.009 |
| | C24:1n9 | Nervonic acid | 1.791 ± 0.077 | 1.923 ± 0.059 |
| Total | | | 28.569 ± 0.071^{a} | 24.840 ± 0.015^{b} |
| Polyunsaturated | C16:2n4 | Hexadecadienoic acid | 0.940 ± 0.028 | 0.950 ± 0.043 |
| | C18:2n6 trans | Linolelaidic acid | 0.120 ± 0.016 | 0.167 ± 0.034 |
| | C18:2n6 cis | Linoleic acid | 0.346 ± 0.021 | 0.291 ± 0.004 |
| | C18:2n4 | 11,14-Octadecadienoic acid | 0.366 ± 0.003 | 0.464 ± 0.000 |
| | C20:2n6 | 11,14-eicosadienoic acid | 0.238 ± 0.011 | 0.222 ± 0.007 |
| | C22:2n6 | 13,16-Docosadienoic acid | 0.194 ± 0.008 | 0.121 ± 0.003 |
| | C16:3n4 | 6,9,12-hexadecatrienoic acid | 0.555 ± 0.007 | 0.426 ± 0.010 |
| | C18:3n4 | 8,11,14-octadecatrienoic acid | 0.134 ± 0.007 | 0.103 ± 0.006 |
| | C18:3n3 | α-Linolenic acid (ALA) | 0.176 ± 0.015 | 0.219 ± 0.002 |
| | C16:4n1 | 6,9,12,15-hexadecatetraenoic acid | 1.920 ± 0.019 | 1.231 ± 0.006 |
| | C18:4n3 | Stearidonic acid | 0.971 ± 0.006 | 0.837 ± 0.003 |
| | C20:4n6 | Arachidonic acid | 0.457 ± 0.022 | 0.509 ± 0.051 |
| | C20:4n3 | Eicosatetraenoic acid (ETA) | 0.265 ± 0.009 | 0.256 ± 0.005 |
| | C20:5n3 | Eicosapentaenoic acid (EPA) | 24.070 ± 0.577^{a} | 21.290 ± 0.210^{b} |
| | C21:5n3 | Heneicosapentaenoic acid (HPA) | 0.821 ± 0.014 | 0.648 ± 0.030 |
| | C22:5n3 | Docosapentaenoic acid (DPA) | 0.254 ± 0.006 | 0.269 ± 0.010 |
| | C22:6n3 | Docosahexaenoic acid (DHA) | 1.278 ± 0.020 | 0.984 ± 0.013 |
| Total of Omega-3 | | | 27.834 ± 0.615^{a} | 24.502 ± 0.222^{c} |
| Total of Omega-6 | | | 1.356 ± 0.023^{a} | 1.311 ± 0.038^{ab} |
| Total | | | 33.104 ± 0.586^{a} | 28.987 ± 0.164^{c} |
| Branched | 4,8,12-Me-13:0 | 4,8,12-Trimethyltridecanoic acid | 1.935 ± 0.028 | 2.628 ± 0.027 |
| | Me-14:0 isomer 1 | Methyltridecanoic acid | 0.463 ± 0.005 | 0.588 ± 0.006 |
| | Me-14:0 isomer 2 | | 0.368 ± 0.005 | 0.430 ± 0.005 |
| | Me-14:0 isomer 3 | | 0.202 ± 0.002 | 0.384 ± 0.003 |
| | i-16:0 | 14-methylpentadecanoic acid | 2.526 ± 0.016 | 4.539 ± 0.019 |
| | i-17:0 | 15-methylhexadecanoic acid | 0.194 ± 0.002 | 0.260 ± 0.001 |
| | ai-15:0 | 12-methyltetradecanoic acid | 17.648 ± 0.115^{d} | 22.532 ± 0.171^{b} |
| | ai-17:0 | 14-methylhexadecanoic acid | 0.889 ± 0.010 | 0.955 ± 0.033 |
| Total | | | 24.225 ± 0.151^{c} | 32.317 ± 0.245^{d} |
| Others¹ | | | 3.769 ± 0.495^{ab} | 3.622 ± 0.068^{b} |

¹Others refer to fatty acid isomers presented in the sample GC chromatograph.

The results indicated the lipidic profiles of fresh Cucumaria frondosa viscera were significantly different from those of hot air-dried and freeze-dried viscera, but the fatty acids composition of hot air-dried and freeze-dried viscera were comparable. In these samples, EPA, C16:1n7, and 12-MTA constituted the primary fatty acids, among which, EPA was the predominant fatty acid in fresh viscera accounting for 24.587%, while 12-MTA was the predominant fatty acid in hot air-dried and freeze-dried samples comprising 24.173% and 26.757% respectively. Moreover, hot air-dried and freeze-dried samples contained 19.834% and 18.616% of EPA, respectively. In addition to EPA, DHA was also present in those samples, but at a very low amount of 1.007-1.458%. Compared with dried samples, fresh samples comprised significantly higher portions of saturated fatty acids, monounsaturated fatty acids, and PUFAs (including omega-3) in the total. Without wishing to be bound by theory, that might be attributed to the loss of these fatty acids caused by hydrolysis and/or oxidation during the pre-treatment process. As such, the dehydration level affects the fatty acid composition of sea cucumber by-products.

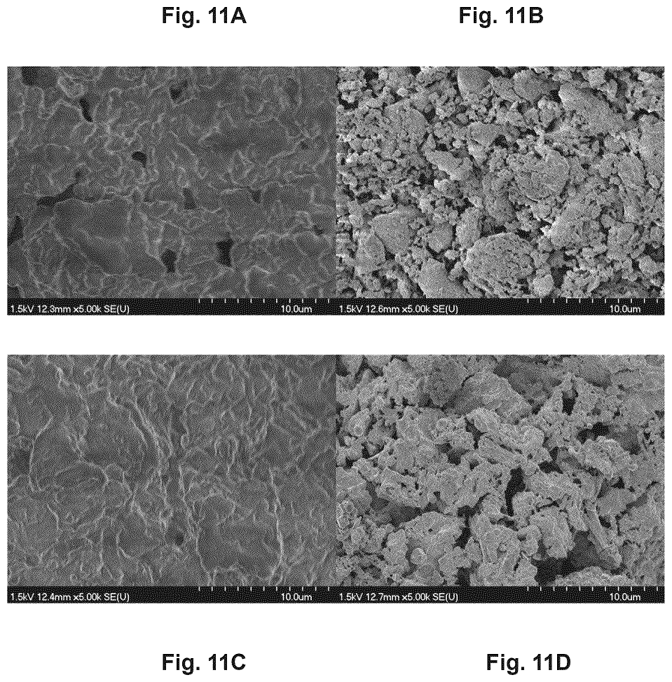

To obtain a better understanding of samples undergoing different drying methods, hot air-dried and freeze-dried samples before and after scCO₂ extraction, SEM was employed to analyze these samples. Compared with FIG. 11A, the surface structure of FIG. 11C shows more obvious cracks and alternation after pre-treatments, indicating that freeze-drying led to alteration of the biomass surface. Sample rigidity was stronger for hot air-dried samples because of the low drying temperature and higher moisture content. The lower rigidity of freeze-dried samples made them easier to be broken into smaller particles under the stream of scCO₂, leading to a larger surface area and then further increasing the contact with extraction solvents. Therefore, freeze-drying improved the mass transfer within samples while simultaneously scCO₂ could penetrate the freeze-dried sample matrix more sufficiently, enhancing lipid dissolution (FIG. 11D exhibits more apparent fractures and pores on freeze-dried samples after extraction compared with FIG. 11B), and hence, the fatty acids yields.

### 3.3.2. Effects of Ethanol-Soaking

To examine the feasibility of ethanol-soaking pre-treatment, fresh and hot air-dried Cucumaria frondosa viscera were soaked into 95% ethanol, followed by scCO₂ extraction under the optimum conditions. The results were presented in Table 8, showing ethanol-soaking pre-treatment significantly increased the extraction yields of fresh viscera achieving almost triple the yields obtained from fresh samples without ethanol-soaking. It was also reported scCO₂ extraction of ethanol-soaked fresh samples, hot air-dried samples, and ethanol-soaked hot air-dried samples led to a similar recovery of the selected omega-3 fatty acids. It was worthwhile to notice ethanol-soaking did not significantly improve the extraction of fatty acids from hot air-dried viscera. Without wishing to be bound by theory, that might be because the ethanol-soaking was not able to exchange a very small amount of moisture and did not further modify the micro-structure of hot air-dried samples. Although ethanol-soaking pre-treatment enhanced the extraction of fatty acids from fresh samples, freeze-drying still assisted in recovering the most fatty acids. Table 10 demonstrates the fatty acid profiles of ethanol-soaked fresh viscera and hot air-dried viscera, showing that ethanol-soaking pre-treatment does not change the fatty acid composition to some extent.

Despite the freeze-dried starting material leading to higher product yield compared to hot-air drying and ethanol soaking of fresh material, it is energy-intensive, consuming approximately four to ten times more energy than hot-air drying. This increase in energy consumption contributes to higher environmental impacts, a crucial consideration in today's ecologically conscious market. Additionally, scaling up freeze-drying for industrial applications presents difficulties, impeding its practicality and widespread adoption in various industries; and it is inherently costly, posing financial challenges to industries. Hot air-drying is also energy intensive but typically has lower energy consumption compared to freeze drying. These limitations highlight the need for innovative pretreatment within the extraction process, such as ethanol-soaking of fresh material, which is less energy intensive compared to freeze drying.

1. A method for extracting fatty acids from a lipid-rich marine organism starting material comprising:
a) exposing the starting material to a supercritical fluid at a defined temperature and a defined pressure; and
b) collecting the extract containing the fatty acids.

2. The method of claim 1, wherein the supercritical fluid is supercritical carbon dioxide.

3. The method of claim 1, wherein the defined temperature is about 35° C. to about 75° C.

4. The method of claim 1, wherein the defined pressure is about 20 MPa to about 50 MPa.

5. The method of claim 1, wherein a co-solvent is included with the starting material prior to exposing the starting material to the supercritical fluid.

6. The method of claim 5, wherein the co-solvent is ethanol.

7. The method of claim 5, wherein the ratio of the co-solvent to the starting material is about 1:1 to about 5:1 by weight.

8. The method of claim 1, wherein the starting material undergoes a dynamic extraction in which the supercritical fluid flows continuously over the starting sample, a static extraction in which the supercritical fluid bathes the starting material, a static extraction followed by a dynamic extraction, or a dynamic extraction followed by a static extraction.

9. The method of claim 8, wherein the supercritical fluid flows at a rate of about 10 ml/min.

10. The method of claim 8, wherein the length of time of the dynamic extraction is about 30 minutes.

11. The method of claim 8, wherein the length of time of the static extraction is about 20 minutes.

12. The method of claim 1, wherein prior to step a), the starting material is freeze-dried or air-dried.

13. The method of claim 1, wherein prior to step a), the starting material is soaked in an organic solvent.

14. The method of claim 13, wherein the organic solvent is ethanol.

15. The method of claim 13, wherein the starting material is fresh.

16. The method of claim 13, wherein after soaking the starting material in the organic solvent, the organic solvent is used as a co-solvent during the supercritical fluid extraction.

17. The method of claim 1, wherein prior to step a), the starting material is pulverized.

18. The method of claim 1, wherein the lipid-rich marine organism is a sea cucumber.

19. The method of claim 18, wherein the sea cucumber is Cucumaria frondosa.

20. The method of claim 1, wherein the fatty acids comprise polyunsaturated fatty acids (PUFAs), omega-3 fatty acids, eicosapentaenoic acid (EPA), docosahexaenoic acid (DHA), or a combination thereof.
